(19) United States
(12) Patent Application Publication
(10) Pub. No.: US 2025/0029283 A1
(43) Pub. Date: Jan. 23, 2025

(54) Coding Point Cloud Attributes

(71) Applicant: Comcast Cable Communications, LLC, Philadelphia, PA (US)

(72) Inventors: Jonathan Taquet, Talensac (FR); Sébastien Lasserre, Thorigné-Fouillard (FR)

(21) Appl. No.: 18/771,342

(22) Filed: Jul. 12, 2024

Related U.S. Application Data
(60) Provisional application No. 63/620,452, filed on Jan. 12, 2024.
(60) Provisional application No. 63/543,770, filed on Oct. 12, 2023.
(60) Provisional application No. 63/526,537, filed on Jul. 13, 2023.

(51) Int. Cl. G06T 9/00

(52) U.S. Cl. CPC G06T 9/00

(57) ABSTRACT

Systems, apparatuses, methods, and computer-readable media are described for determining and/or coding attribute information in a point cloud frame. The attribute information may be encoded based on one or more attribute predictors. The attribute predictors may be determined based on projecting attributes of a reference point cloud frame onto a geometry of a current point cloud frame. The same attribute predictors may be omitted from the encoded bitstream and generated by a decode.

### CROSS-REFERENCE TO RELATED APPLICATIONS

This application claims the benefit of U.S. Provisional Application No. 63/526,537 filed on Jul. 13, 2023, U.S. Provisional Application No. 63/543,770 filed on Oct. 12, 2023, and U.S. Provisional Application No. 63/620,452 filed on Jan. 12, 2024. The above referenced applications are hereby incorporated by reference in their entirety.

### BACKGROUND

An object or scene may be described using volumetric visual data consisting of a series of points. The points may be stored as a point cloud format that includes a collection of points in three-dimensional space. As point clouds can get quite large in data size, transmitting and processing point cloud data may need a data compression scheme that is specifically designed with respect to the unique characteristics of point cloud data.

### SUMMARY

The following summary presents a simplified summary of certain features. The summary is not an extensive overview and is not intended to identify key or critical elements.

Point cloud frames associated with content may comprise geometry information and attribute information (e.g., color or texture of the geometry). Attribute information may be coded separately from geometry information. A reference point cloud frame may be selected for predicting attributes of a current point cloud frame. One or more attribute predictors may be determined, for example, based on projecting attributes, of the reference point cloud frame, onto a geometry of the current point cloud frame. An encoder may encode residual attributes that indicate differences between the (original or target) attributes and the attribute predictors. A decoder may obtain the attribute information by generating the attribute predictors and decoding received residual attributes. By encoding the residual attributes, for example, without encoding the (original or target) attributes and/or the attribute predictors, coding costs (e.g., bitrate) and/or distortion for inter-frame prediction may be reduced.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example point cloud coding system.

FIG. 2 shows an example Morton order.

FIG. 3 shows an example scanning order.

FIG. 4 shows an example neighborhood of cuboids for entropy coding the occupancy of a child cuboid.

FIG. 5 shows an example of a dynamic reduction function DR that may be used in dynamic OBUF.

FIG. 6 shows an example method for coding occupancy of a cuboid using dynamic OBUF.

FIG. 7 shows an example of an occupied cuboid.

FIG. 8A shows an example cuboid corresponding to a TriSoup node.

FIG. 8B shows an example refinement to the TriSoup model.

FIG. 9 shows an example of voxelization.

FIG. 10 shows an example encoding method using inter frame prediction.

FIG. 11 shows an example method for encoding point cloud attributes based on prediction transform.

FIG. 12 shows an example method for decoding point cloud attributes based on prediction transform.

FIG. 13 shows an example method for encoding point cloud attributes based on prediction with lifting transform.

FIG. 14 shows an example method for decoding point cloud attributes based on prediction with lifting transform.

FIG. 15 shows example region adaptive hierarchical transform (RAHT) transformation used for an octree.

FIG. 16 shows another example of the RAHT transformation used for an octree. FIG. 17 shows an example method for encoding point cloud frames.

FIG. 18 shows an example method for decoding point cloud frames.

FIG. 19 shows an example method for encoding attributes of a point cloud frame.

FIG. 20 shows another example method for decoding attributes of a point cloud frame.

FIG. 21 shows another example method for encoding attributes of a point cloud frame.

FIG. 22 shows another example method for decoding attributes of a point cloud frame.

FIG. 23 shows an example method for encoding residual attributes.

FIG. 24 shows an example method for decoding residual attributes.

FIG. 25 shows another example method for encoding attributes of a point cloud frame.

FIG. 26 shows another example method for decoding attributes of a point cloud frame.

FIG. 27 shows an example method for encoding attributes of a point cloud frame.

FIG. 28 shows an example method for decoding attributes of a point cloud frame.

FIG. 29 shows an example computer system in which examples of the present disclosure may be implemented.

FIG. 30 shows example elements of a computing device that may be used to implement any of the various devices described herein.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of point cloud or point cloud sequence encoding or decoding systems. More particularly, the technology disclosed herein may relate to point cloud compression as used in encoding and/or decoding devices and/or systems.

At least some visual data may describe an object or scene in content and/or media using a series of points. Each point may comprise a position in two dimensions (x and y) and one or more optional attributes like color. Volumetric visual data may add another positional dimension to these visual data. For example, volumetric visual data may describe an object or scene in content and/or media using a series of points that each may comprise a position in three dimensions (x, y, and z) and one or more optional attributes like color, reflectance, time stamp, etc. Volumetric visual data may provide a more immersive way to experience visual data, for example, compared to the at least some visual data. For example, an object or scene described by volumetric visual data may be viewed from any (or multiple) angles, whereas the at least some visual data may generally only be viewed from the angle in which it was captured or rendered. As a format for the representation of visual data (e.g., volumetric visual data, three-dimensional video data, etc.) point clouds are versatile in their capability in representing all types of three-dimensional (3D) objects, scenes, and visual content. Point clouds are well suited for use in various applications including, among others: movie post-production, real-time 3D immersive media or telepresence, extended reality, free viewpoint video, geographical information systems, autonomous driving, 3D mapping, visualization, medicine, multi-view replay, and real-time Light Detection and Ranging (LIDAR) data acquisition.

As explained herein, volumetric visual data may be used in many applications, including extended reality (XR). XR encompasses various types of immersive technologies, including augmented reality (AR), virtual reality (VR), and mixed reality (MR). Sparse volumetric visual data may be used in the automotive industry for the representation of three-dimensional (3D) maps (e.g., cartography) or as input to assisted driving systems. In the case of assisted driving systems, volumetric visual data may be typically input to driving decision algorithms. Volumetric visual data may be used to store valuable objects in digital form. In applications for preserving cultural heritage, a goal may be to keep a representation of objects that may be threatened by natural disasters. For example, statues, vases, and temples may be entirely scanned and stored as volumetric visual data having several billions of samples. This use-case for volumetric visual data may be particularly relevant for valuable objects in locations where earthquakes, tsunamis and typhoons are frequent. Volumetric visual data may take the form of a volumetric frame. The volumetric frame may describe an object or scene captured at a particular time instance. Volumetric visual data may take the form of a sequence of volumetric frames (referred to as a volumetric sequence or volumetric video). The sequence of volumetric frames may describe an object or scene captured at multiple different time instances.

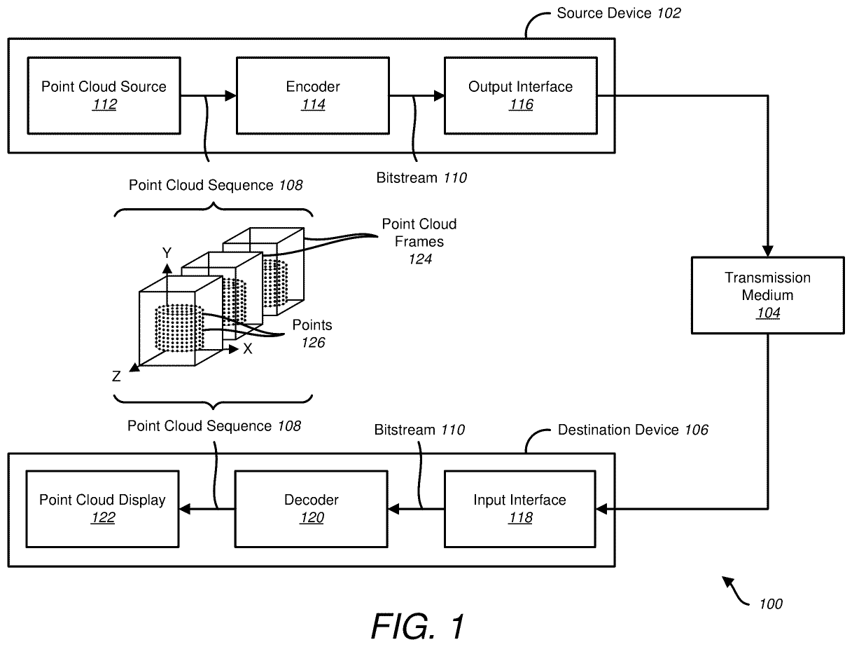

Volumetric visual data may be stored in various formats. A point cloud may comprise a collection of points in a 3D space. Such points may be used create a mesh comprising vertices and polygons, or other forms of visual content. As described herein, point cloud data may take the form of a point cloud frame, which describes an object or scene in content that is captured at a particular time instance. Point cloud data may take the form of a sequence of point cloud frames (e.g., point cloud video). As further described herein, point cloud data may be encoded by a source device (e.g., source device 102 as described herein with respect to FIG. 1) that outputs a bitstream containing the encoded point cloud data. The source device may encode the point cloud data based on point cloud compression coding, for example, geometry-based point cloud compression (G-PCC) coding and/or video-based point cloud compression (V-PCC) coding, or next generation coding. A destination device (e.g., destination device 106 as described herein with respect to FIG. 1) receives the bitstream containing the point cloud data and decodes the bitstream containing the point cloud data. The destination device may decode the point cloud data by performing point cloud decompression coding. The decompression coding may be an inverse process of the point cloud compression coding. The point cloud decompression coding may include, for example, G-PCC coding. Decoding may be used to decompress the point cloud data for display and/or other forms of consumption (e.g., further analysis, storage, etc.). The destination device (or a different device) may include, for example, a renderer for rendering the decoded point cloud data. The renderer may output content, for example, by rendering the point cloud data. The renderer may output content, for example, by rendering the point cloud data along with other data (e.g., audio data).

One format for storing volumetric visual data may be point clouds. A point cloud may comprise a collection of points in 3D space. Each point in a point cloud may comprise geometry information that may indicate the point's position in 3D space. For example, the geometry information may indicate the point's position in 3D space, for example, using three Cartesian coordinates (x, y, and z) and/or using spherical coordinates (r, phi, theta) (e.g., if acquired by a rotating sensor). The positions of points in a point cloud may be quantized according to a space precision. The space precision may be the same or different in each dimension. The quantization process may create a grid in 3D space. One or more points residing within each sub-grid volume may be mapped to the sub-grid center coordinates, referred to as voxels. A voxel may be considered as a 3D extension of pixels corresponding to the 2D image grid coordinates. For example, similar to a pixel being the smallest unit in the example of dividing the 2D space (or 2D image) into discrete, uniform (e.g., equally sized) regions, a voxel may be the smallest unit of volume in the example of dividing 3D space into discrete, uniform regions. A point in a point cloud may comprise one or more types of attribute information. Attribute information may indicate a property of a point's visual appearance. For example, attribute information may indicate a texture (e.g., color) of the point, a material type of the point, transparency information of the point, reflectance information of the point, a normal vector to a surface of the point, a velocity at the point, an acceleration at the point, a time stamp indicating when the point was captured, or a modality indicating how the point was captured (e.g., running, walking, or flying). A point in a point cloud may comprise light field data in the form of multiple view-dependent texture information. Light field data may be another type of optional attribute information.

The points in a point cloud may describe an object or a scene. For example, the points in a point cloud may describe the external surface and/or the internal structure of an object or scene. The object or scene may be synthetically generated by a computer. The object or scene may be generated from the capture of a real-world object or scene. The geometry information of a real-world object or a scene may be obtained by 3D scanning and/or photogrammetry. 3D scanning may include different types of scanning, for example, laser scanning, structured light scanning, and/or modulated light scanning. 3D scanning may obtain geometry information. 3D scanning may obtain geometry information, for example, by moving one or more laser heads, structured light cameras, and/or modulated light cameras relative to an object or scene being scanned. Photogrammetry may obtain geometry information. Photogrammetry may obtain geometry information, for example, by triangulating the same feature or point in different spatially shifted 2D photographs. Point cloud data may take the form of a point cloud frame. The point cloud frame may describe an object or scene captured at a particular time instance. Point cloud data may take the form of a sequence of point cloud frames. The sequence of point cloud frames may be referred to as a point cloud sequence or point cloud video. The sequence of point cloud frames may describe an object or scene captured at multiple different time instances.

The data size of a point cloud frame or point cloud sequence may be excessive (e.g., too large) for storage and/or transmission in many applications. For example, a single point cloud may comprise over a million points or even billions of points. Each point may comprise geometry information and one or more optional types of attribute information. The geometry information of each point may comprise three Cartesian coordinates (x, y, and z) and/or spherical coordinates (r, phi, theta) that may be each represented, for example, using at least 10 bits per component or 30 bits in total. The attribute information of each point may comprise a texture corresponding to a plurality of (e.g., three) color components (e.g., R, G, and B color components). Each color component may be represented, for example, using 8-10 bits per component or 24-30 bits in total. For example, a single point may comprise at least 54 bits of information, with at least 30 bits of geometry information and at least 24 bits of texture. If a point cloud frame includes a million such points, each point cloud frame may require 54 million bits or 54 megabits to represent. For dynamic point clouds that change over time, at a frame rate of 30 frames per second, a data rate of 1.32 gigabits per second may be required to send (e.g., transmit) the points of the point cloud sequence. Raw representations of point clouds may require a large amount of data, and the practical deployment of point-cloud-based technologies may need compression technologies that enable the storage and distribution of point clouds with a reasonable cost.

Encoding may be used to compress and/or reduce the data size of a point cloud frame or point cloud sequence to provide for more efficient storage and/or transmission. Decoding may be used to decompress a compressed point cloud frame or point cloud sequence for display and/or other forms of consumption (e.g., by a machine learning based device, neural network-based device, artificial intelligence-based device, or other forms of consumption by other types of machine-based processing algorithms and/or devices). Compression of point clouds may be lossy (introducing differences relative to the original data) for the distribution to and visualization by an end-user, for example, on AR or VR glasses or any other 3D-capable device. Lossy compression may allow for a high ratio of compression but may imply a trade-off between compression and visual quality perceived by an end-user. Other frameworks, for example, frameworks for medical applications or autonomous driving, may require lossless compression to avoid altering the results of a decision obtained, for example, based on the analysis of the sent (e.g., transmitted) and decompressed point cloud frame.

FIG. 1 shows an example point cloud coding (e.g., encoding and/or decoding) system 100. Point cloud coding system 100 may comprise a source device 102, a transmission medium 104, and a destination device 106. Source device 102 may encode a point cloud sequence 108 into a bitstream 110 for more efficient storage and/or transmission. Source device 102 may store and/or send (e.g., transmit) bitstream 110 to destination device 106 via transmission medium 104. Destination device 106 may decode bitstream 110 to display point cloud sequence 108 or for other forms of consumption (e.g., further analysis, storage, etc.). Destination device 106 may receive bitstream 110 from source device 102 via a storage medium or transmission medium 104. Source device 102 and destination device 106 may include any number of different devices. Source device 102 and destination device 106 may include, for example, a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, a vehicle (e.g., an autonomous vehicle), or a head-mounted display. A head-mounted display may allow a user to view a VR, AR, or MR scene and adjust the view of the scene, for example, based on movement of the user's head. A head-mounted display may be connected (e.g., tethered) to a processing device (e.g., a server, a desktop computer, a set-top box, or a video gaming console) or may be fully self-contained.

A source device 102 may comprise a point cloud source 112, an encoder 114, and an output interface 116. A source device 102 may comprise a point cloud source 112, an encoder 114, and an output interface 116, for example, to encode point cloud sequence 108 into a bitstream 110. Point cloud source 112 may provide (e.g., generate) point cloud sequence 108, for example, from a capture of a natural scene and/or a synthetically generated scene. A synthetically generated scene may be a scene comprising computer generated graphics. Point cloud source 112 may comprise one or more point cloud capture devices, a point cloud archive comprising previously captured natural scenes and/or synthetically generated scenes, a point cloud feed interface to receive captured natural scenes and/or synthetically generated scenes from a point cloud content provider, and/or a processor(s) to generate synthetic point cloud scenes. The point cloud capture devices may include, for example, one or more laser scanning devices, structured light scanning devices, modulated light scanning devices, and/or passive scanning devices.

Point cloud sequence 108 may comprise a series of point cloud frames 124 (e.g., an example shown in FIG. 1). A point cloud frame may describe an object or scene captured at a particular time instance. Point cloud sequence 108 may achieve the impression of motion by using a constant or variable time to successively present point cloud frames 124 of point cloud sequence 108. A point cloud frame may comprise a collection of points (e.g., voxels) 126 in 3D space. Each point 126 may comprise geometry information that may indicate the point's position in 3D space. The geometry information may indicate, for example, the point's position in 3D space using three Cartesian coordinates (x, y, and z). One or more of points 126 may comprise one or more types of attribute information. Attribute information may indicate a property of a point's visual appearance. For example, attribute information may indicate, for example, a texture (e.g., color) of a point, a material type of a point, transparency information of a point, reflectance information of a point, a normal vector to a surface of a point, a velocity at a point, an acceleration at a point, a time stamp indicating when a point was captured, a modality indicating how a point was captured (e.g., running, walking, or flying), etc. One or more of points 126 may comprise, for example, light field data in the form of multiple view-dependent texture information. Light field data may be another type of optional attribute information. Color attribute information of one or more of points 126 may comprise a luminance value and two chrominance values. The luminance value may represent the brightness (e.g., luma component, Y) of the point. The chrominance values may respectively represent the blue and red components of the point (e.g., chroma components, Cb and Cr) separate from the brightness. Other color attribute values may be represented, for example, based on different color schemes (e.g., an RGB or monochrome color scheme).

Encoder 114 may encode point cloud sequence 108 into a bitstream 110. To encode point cloud sequence 108, encoder 114 may use one or more lossless or lossy compression techniques to reduce redundant information in point cloud sequence 108. To encode point cloud sequence 108, encoder 114 may use one or more prediction techniques to reduce redundant information in point cloud sequence 108. Redundant information is information that may be predicted at a decoder 120 and may not be needed to be sent (e.g., transmitted) to decoder 120 for accurate decoding of point cloud sequence 108. For example, Motion Picture Expert Group (MPEG) introduced a geometry-based point cloud compression (G-PCC) standard (ISO/IEC standard 23090-9: Geometry-based point cloud compression). G-PCC specifies the encoded bitstream syntax and semantics for transmission and/or storage of a compressed point cloud frame and the decoder operation for reconstructing the compressed point cloud frame from the bitstream. During standardization of G-PCC, a reference software (ISO/IEC standard 23090-21: Reference Software for G-PCC) was developed to encode the geometry and attribute information of a point cloud frame. To encode geometry information of a point cloud frame, the G-PCC reference software encoder may perform voxelization. The G-PCC reference software encoder may perform voxelization, for example, by quantizing positions of points in a point cloud. Quantizing positions of points in a point cloud may create a grid in 3D space. The G-PCC reference software encoder may map the points to the center coordinates of the sub-grid volume (e.g., voxel) that their quantized locations reside in. The G-PCC reference software encoder may perform geometry analysis using an occupancy tree to compress the geometry information. The G-PCC reference software encoder may entropy encode the result of the geometry analysis to further compress the geometry information. To encode attribute information of a point cloud, the G-PCC reference software encoder may use a transform tool, such as Region Adaptive Hierarchical Transform (RAHT), the Predicting Transform, and/or the Lifting Transform. The Lifting Transform may be built on top of the Predicting Transform. The Lifting Transform may include an extra update/lifting step. The Lifting Transform and the Predicting Transform may be referred to as Predicting/Lifting Transform or pred lift. Encoder 114 may operate in a same or similar manner to an encoder provided by the G-PCC reference software.

Output interface 116 may be configured to write and/or store bitstream 110 onto transmission medium 104. The bitstream 110 may be sent (e.g., transmitted) to destination device 106. In addition or alternatively, output interface 116 may be configured to send (e.g., transmit), upload, and/or stream bitstream 110 to destination device 106 via transmission medium 104. Output interface 116 may comprise a wired and/or wireless transmitter configured to send (e.g., transmit), upload, and/or stream bitstream 110 according to one or more proprietary, open-source, and/or standardized communication protocols. The one or more proprietary, open-source, and/or standardized communication protocols may include, for example, Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one or more networks (e.g., the Internet) or file server(s) configured to store and/or send (e.g., transmit) encoded video data.

Destination device 106 may decode bitstream 110 into point cloud sequence 108 for display or other forms of consumption. Destination device 106 may comprise one or more of an input interface 118, a decoder 120, and/or a point cloud display 122. Input interface 118 may be configured to read bitstream 110 stored on transmission medium 104. Bitstream 110 may be stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary, open-source, standardized communication protocols, and/or any other communication protocol. Examples of the protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Decoder 120 may decode point cloud sequence 108 from encoded bitstream 110. For example, decoder 120 may operate in a same or similar manner as a decoder provided by G-PCC reference software. Decoder 120 may decode a point cloud sequence that approximates a point cloud sequence 108. Decoder 120 may decode a point cloud sequence that approximates a point cloud sequence 108 due to, for example, lossy compression of the point cloud sequence 108 by encoder 114 and/or errors introduced into encoded bitstream 110, for example, if transmission to destination device 106 occurs.

Point cloud display 122 may display a point cloud sequence 108 to a user. The point cloud display 122 may comprise, for example, a cathode rate tube (CRT) display, a liquid crystal display (LCD), a plasma display, a light emitting diode (LED) display, a 3D display, a holographic display, a head-mounted display, or any other display device suitable for displaying point cloud sequence 108.

Point cloud coding (e.g., encoding/decoding) system 100 is presented by way of example and not limitation. Point cloud coding systems different from the point cloud coding system 100 and/or modified versions of the point cloud coding system 100 may perform the methods and processes as described herein. For example, the point cloud coding system 100 may comprise other components and/or arrangements. Point cloud source 112 may, for example, be external to source device 102. Point cloud display device 122 may, for example, be external to destination device 106 or omitted altogether (e.g., if point cloud sequence 108 is intended for consumption by a machine and/or storage device). Source device 102 may further comprise, for example, a point cloud decoder. Destination device 106 may comprise, for example, a point cloud encoder. For example, source device 102 may be configured to further receive an encoded bit stream from destination device 106. Receiving an encoded bit stream from destination device 106 may support two-way point cloud transmission between the devices.

As described herein, an encoder may quantize the positions of points in a point cloud according to a space precision, which may be the same or different in each dimension of the points. The quantization process may create a grid in 3D space. The encoder may map any points residing within each sub-grid volume to the sub-grid center coordinates, referred to as a voxel or a volumetric pixel. A voxel may be considered as a 3D extension of pixels corresponding to 2D image grid coordinates.

An encoder may represent or code a point cloud (e.g., a voxelized). An encoder may represent or code a point cloud, for example, using an occupancy tree. For example, the encoder may split the initial volume or cuboid containing the point cloud into sub-cuboids. The initial volume or cuboid may be referred to as a bounding box. A cuboid may be, for example, a cube. The encoder may recursively split each sub-cuboid that contains at least one point of the point cloud. The encoder may not further split sub-cuboids that do not contain at least one point of the point cloud. A sub-cuboid that contains at least one point of the point cloud may be referred to as an occupied sub-cuboid. A sub-cuboid that does not contain at least one point of the point cloud may be referred to as an unoccupied sub-cuboid. The encoder may split an occupied sub-cuboid into, for example, two sub-cuboids (to form a binary tree), four sub-cuboids (to form a quadtree), or eight sub-cuboids (to form an octree). The encoder may split an occupied sub-cuboid to obtain further sub-cuboids. The sub-cuboids may have the same size and shape at a given depth level of the occupancy tree. The sub-cuboids may have the same size and shape at a given depth level of the occupancy tree, for example, if the encoder splits the occupied sub-cuboid along a plane passing through the middle of edges of the sub-cuboid.

The initial volume or cuboid containing the point cloud may correspond to the root node of the occupancy tree. Each occupied sub-cuboid, split from the initial volume, may correspond to a node (of the root node) in a second level of the occupancy tree. Each occupied sub-cuboid, split from an occupied sub-cuboid in the second level, may correspond to a node (off the occupied sub-cuboid in the second level from which it was split) in a third level of the occupancy tree. The occupancy tree structure may continue to form in this manner for each recursive split iteration until, for example, some maximum depth level of the occupancy tree is reached or each occupied sub-cuboid has a volume corresponding to one voxel.

Each non-leaf node of the occupancy tree may comprise or be associated with an occupancy word representing the occupancy state of the cuboid corresponding to the node. For example, a node of the occupancy tree corresponding to a cuboid that is split into 8 sub-cuboids may comprise or be associated with a 1-byte occupancy word. Each bit (referred to as an occupancy bit) of the 1-byte occupancy word may represent or indicate the occupancy of a different one of the eight sub-cuboids. Occupied sub-cuboids may be each represented or indicated by a binary “1” in the 1-byte occupancy word. Unoccupied sub-cuboids may be each represented or indicated by a binary “0” in the 1-byte occupancy word. Occupied and un-occupied sub-cuboids may be represented or indicated by opposite 1-bit binary values (e.g., a binary “0” representing or indicating an occupied sub-cuboid and a binary “1” representing or indicating an unoccupied sub-cuboid) in the 1-byte occupancy word.

Each bit of an occupancy word may represent or indicate the occupancy of a different one of the eight sub-cuboids. Each bit of an occupancy word may represent or indicate the occupancy of a different one of the eight sub-cuboids, for example, following the so-called Morton order. For example, the least significant bit of an occupancy word may represent or indicate, for example, the occupancy of a first one of the eight sub-cuboids following the Morton order. The second least significant bit of an occupancy word may represent or indicate, for example, the occupancy of a second one of the eight sub-cuboids following the Morton order, etc.

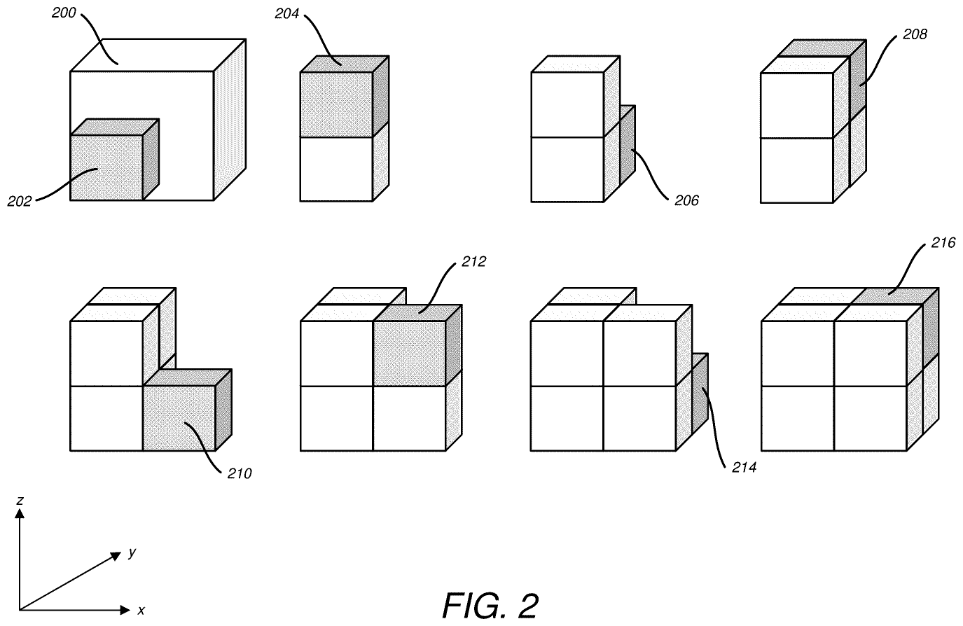

FIG. 2 shows an example Morton order. More specifically, FIG. 2 shows a Morton order of eight sub-cuboids 202-216 split from a cuboid 200. Sub-cuboids 202-216 may be labeled, for example, based on their Morton order, with child node 202 being the first in Morton order and child node 216 being the last in Morton order. The Morton order for sub-cuboids 202-216 may be a local lexicographic order in xyz.

The geometry of a point cloud may be represented by, and may be determined from, the initial volume and the occupancy words of the nodes in an occupancy tree. An encoder may send (e.g., transmit) the initial volume and the occupancy words of the nodes in the occupancy tree in a bitstream to a decoder for reconstructing the point cloud. The encoder may entropy encode the occupancy words. The encoder may entropy encode the occupancy words, for example, before sending (e.g., transmitting) the initial volume and the occupancy words of the nodes in the occupancy tree. The encoder may encode an occupancy bit of an occupancy word of a node corresponding to a cuboid. The encoder may encode an occupancy bit of an occupancy word of a node corresponding to a cuboid, for example, based on one or more occupancy bits of occupancy words of other nodes corresponding to cuboids that are adjacent or spatially close to the cuboid of the occupancy bit being encoded.

An encoder and/or a decoder may code (e.g., encode and/or decode) occupancy bits of occupancy words in sequence of a scan order. The scan order may also be referred to as a scanning order. For example, an encoder and/or a decoder may scan an occupancy tree in breadth-first order. All the occupancy words of the nodes of a given depth (e.g., level) within the occupancy tree may be scanned. All the occupancy words of the nodes of a given depth (e.g., level) within the occupancy tree may be scanned, for example, before scanning the occupancy words of the nodes of the next depth (e.g., level). Within a given depth, the encoder and/or decoder may scan the occupancy words of nodes in the Morton order. Within a given node, the encoder and/or decoder may scan the occupancy bits of the occupancy word of the node further in the Morton order.

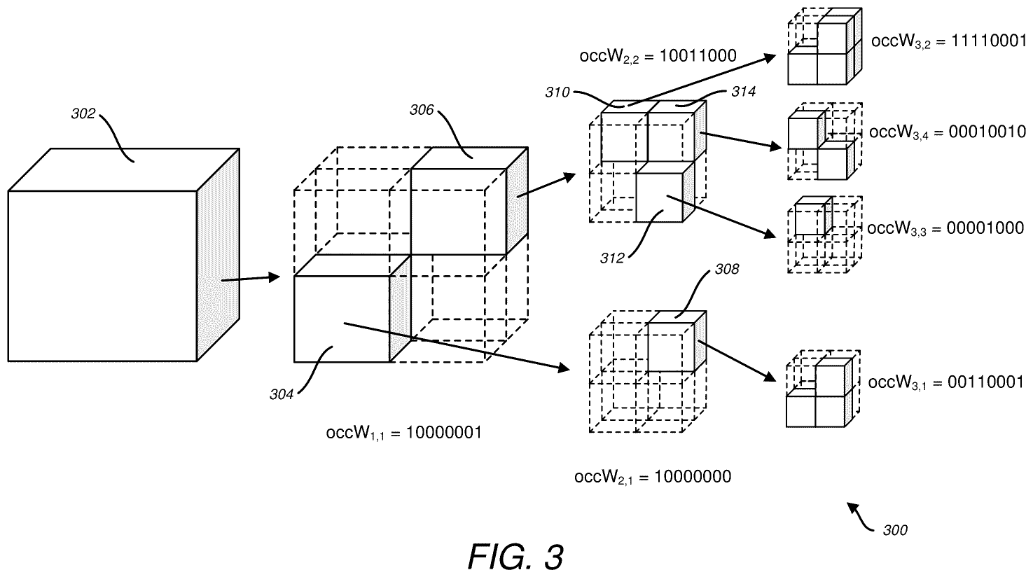

FIG. 3 shows an example scanning order. FIG. 3 shows an example scanning order (e.g., breadth-first order as described herein) for an occupancy tree 300. More specifically, FIG. 3 shows a scanning order for the first three example levels of an occupancy tree 300. In FIG. 3, a cuboid (e.g., cube) 302 corresponding to a root node of the occupancy tree 300 may be divided into eight sub-cuboids (e.g., sub-cubes). Two sub-cuboids 304 and 306 of the eight sub-cuboids may be occupied. The other six sub-cuboids of the eight sub-cuboids may be unoccupied. Following the Morton order, a first eight-bit occupancy word (e.g., occW_{1,1}) may be constructed to represent the occupancy word of the root node. An (e.g., each) occupancy bit of the first eight-bit occupancy word (e.g., occW_{1,1}) may represent or indicate the occupancy of a sub-cube of the eight sub-cuboids in the Morton order. For example, the least significant occupancy bit of the first eight-bit occupancy word occW_{1,1} may represent or indicate the occupancy of the first sub-cuboid of the eight sub-cuboids in the Morton order. The second least significant occupancy bit of the first eight-bit occupancy word occW_{1,1} may represent or indicate the occupancy of the second sub-cuboid of the eight sub-cuboids in the Morton order, etc.

Each of occupied sub-cuboids (e.g., two occupied sub-cuboids 304 and 306) may correspond to a node off the root node in a second level of an occupancy tree 300. The occupied sub-cuboids (e.g., two occupied sub-cuboids 304 and 306) may be each further split into eight sub-cuboids. For example, one of the sub-cuboids 308 of the eight sub-cuboids split from the sub-cube 304 may be occupied, and the other seven sub-cuboids may be unoccupied. Three of the sub-cuboids 310, 312, and 314 of the eight sub-cuboids split from the sub-cube 306 may be occupied, and the other five sub-cuboids of the eight sub-cuboids split from the sub-cube 306 may be unoccupied. Two second eight-bit occupancy words occW_{2,1} and occW_{2,2} may be constructed in this order to respectively represent the occupancy word of the node corresponding to the sub-cuboid 304 and the occupancy word of the node corresponding to the sub-cuboid 306.

Each of occupied sub-cuboids (e.g., four occupied sub-cuboids 308, 310, 312, and 314) may correspond to a node in a third level of an occupancy tree 300. The occupied sub-cuboids (e.g., four occupied sub-cuboids 308, 310, 312, and 314) may be each further split into eight sub-cuboids or 32 sub-cuboids in total. For example, four third level eight-bit occupancy words occW_{3,1}, occW_{3,2}, occW_{3,3} and occW_{3,4} may be constructed in this order to respectively represent the occupancy word of the node corresponding to the sub-cuboid 308, the occupancy word of the node corresponding to the sub-cuboid 310, the occupancy word of the node corresponding to the sub-cuboid 312, and the occupancy word of the node corresponding to the sub-cuboid 314.

Occupancy words of an example occupancy tree 300 may be entropy coded (e.g., entropy encoded by an encoder and/or entropy decoded by a decoder), for example, following the scanning order discussed herein (e.g., Morton order). The occupancy words of the example occupancy tree 300 may be entropy coded (e.g., entropy encoded by an encoder and/or entropy decoded by a decoder) as the succession of the seven occupancy words occW_{1,1} to occW_{3,4}, for example, following the scanning order discussed herein. The scanning order discussed herein may be a breadth-first scanning order. The occupancy word(s) of all node(s) having the same depth (or level) as a current parent node may have already been entropy coded, for example, if the occupancy word of a current child node belonging to the current parent node is being entropy coded. For example, the occupancy word(s) of all node(s) having the same depth (e.g., level) as the current child node and having a lower Morton order than the current child node may have also already been entropy coded. Part of the already coded occupancy word(s) may be used to entropy code the occupancy word of the current child node. The already coded occupancy word(s) of neighboring parent and child node(s) may be used, for example, to entropy code the occupancy word of the current child node. The occupancy bit(s) of the occupancy word having a lower Morton order than a particular occupancy bit may have also already been entropy coded and may be used to code the occupancy bit of the occupancy word of the current child node, for example, if the particular occupancy bit of the occupancy word of the current child node is being coded (e.g., entropy coded).

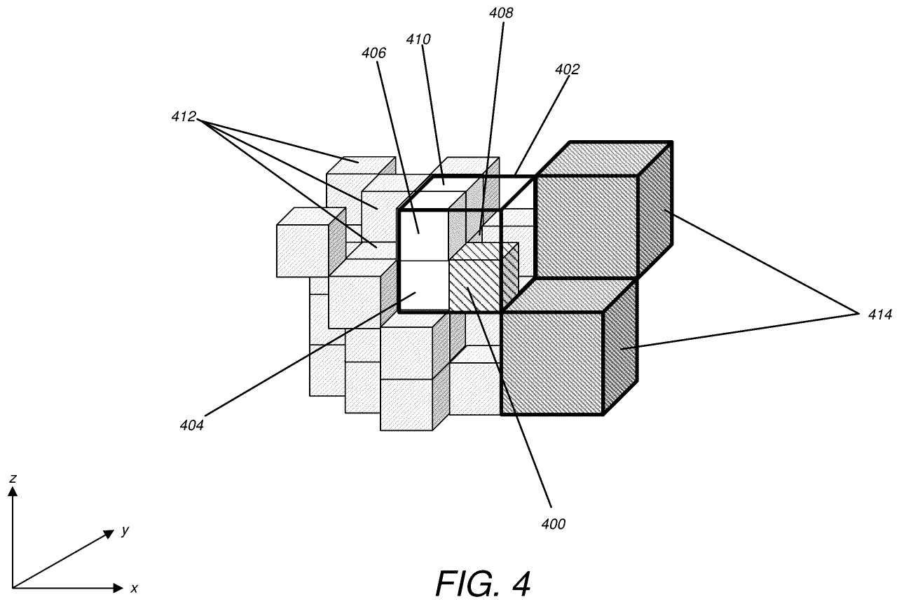

FIG. 4 shows an example neighborhood of cuboids for entropy coding the occupancy of a child cuboid. More specifically, FIG. 4 shows an example neighborhood of cuboids with already-coded occupancy bits. The neighborhood of cuboids with already-coded occupancy bits may be used to entropy code the occupancy bit of a current child cuboid 400. The neighborhood of cuboids with already-coded occupancy bits may be determined, for example, based on the scanning order of an occupancy tree representing the geometry of the cuboids in FIG. 4 as discussed herein. The neighborhood of cuboids, of a current child cuboid, may include one or more of: a cuboid adjacent to the current child cuboid, a cuboid sharing a vertex with the current child cuboid, a cuboid sharing an edge with the current child cuboid, a cuboid sharing a face with the current child cuboid, a parent cuboid adjacent to the current child cuboid, a parent cuboid sharing a vertex with the current child cuboid, a parent cuboid sharing an edge with the current child cuboid, a parent cuboid sharing a face with the current child cuboid, a parent cuboid adjacent to the current parent cuboid, a parent cuboid sharing a vertex with the current parent cuboid, a parent cuboid sharing an edge with the current parent cuboid, a parent cuboid sharing a face with the current parent cuboid, etc. As shown in FIG. 4, current child cuboid 400 may belong to a current parent cuboid 402. Following the scanning order of the occupancy words and occupancy bits of nodes of the occupancy tree, the occupancy bits of four child cuboids 404, 406, 408, and 410, belonging to the same current parent cuboid 402, may have already been coded. The occupancy bit of child cuboids 412 of preceding parent cuboids may have already been coded. The occupancy bits of parent cuboids 414, for which the occupancy bits of child cuboids have not already been coded, may have already been coded. The already-coded occupancy bits of cuboids 404, 406, 408, 410, 412, and 414 may be used to code the occupancy bit of the current child cuboid 400.

The number (e.g., quantity) of possible occupancy configurations (e.g., sets of one or more occupancy words and/or occupancy bits) for a neighborhood of a current child cuboid may be 2^{N}, where N is the number (e.g., quantity) of cuboids in the neighborhood of the current child cuboid with already-coded occupancy bits. The neighborhood of the current child cuboid may comprise several dozens of cuboids. The neighborhood of the current child cuboid (e.g., several dozens of cuboids) may comprise 26 adjacent parent cuboids sharing a face, an, edge, and/or a vertex with the parent cuboid of the current child cuboid and also several adjacent child cuboids having occupancy bits already coded sharing a face, an edge, or a vertex with the current child cuboid. The occupancy configuration for a neighborhood of the current child cuboid may have billions of possible occupancy configurations, even limited to a subset of the adjacent cuboids, making its direct use impractical. An encoder and/or decoder may use the occupancy configuration for a neighborhood of the current child cuboid to select the context (e.g., a probability model), among a set of contexts, of a binary entropy coder (e.g., binary arithmetic coder) that may code the occupancy bit of the current child cuboid. The context-based binary entropy coding may be similar to the Context Adaptive Binary Arithmetic Coder (CABAC) used in MPEG-H Part 2 (also known as High Efficiency Video Coding (HEVC)).

An encoder and/or a decoder may use several methods to reduce the occupancy configurations for a neighborhood of a current child cuboid being coded to a practical number (e.g., quantity) of reduced occupancy configurations. The 2⁶ or 64 occupancy configurations of the six adjacent parent cuboids sharing a face with the parent cuboid of the current child cuboid may be reduced to 9 occupancy configurations. The occupancy configurations may be reduced by using geometry invariance. An occupancy score for the current child cuboid may be obtained from the 2²⁶ occupancy configurations of the 26 adjacent parent cuboids. The score may be further reduced into a ternary occupancy prediction (e.g., “predicted occupied,” “unsure”, or “predicted unoccupied”) by using score thresholds. The number (e.g., quantity) of occupied adjacent child cuboids and the number (e.g., quantity) of unoccupied adjacent child cuboids may be used instead of the individual occupancies of these child cuboids.

An encoder and/or a decoder using/employing one or more of the methods described herein may reduce the number (e.g., quantity) of possible occupancy configurations for a neighborhood of a current child cuboid to a more manageable number (e.g., a few thousands). It has been observed that instead of associating a reduced number (e.g., quantity) of contexts (e.g., probability models) directly to the reduced occupancy configurations, another mechanism may be used, namely Optimal Binary Coders with Update on the Fly (OBUF). An encoder and/or a decoder may implement OBUF to limit the number (e.g., quantity) of contexts to a lower number (e.g., 32 contexts).

OBUF may use a limited number (e.g., 32) of contexts (e.g., probability models). The number (e.g., quantity) of contexts in OBUF may be a fixed number (e.g., fixed quantity). The contexts used by OBUF may be ordered, referred to by a context index (e.g., a context index in the range of 0 to 31), and associated from a lowest virtual probability to a highest virtual probability to code a “1”. A Look-Up Table (LUT) of context indices may be initialized at the beginning of a point cloud coding process. For example, the LUT may initially point to a context (e.g., with a context index 15) with the median virtual probability to code a “1” for all input. The LUT may initially point to a context with the median virtual probability to code a “1”, among the limited number (e.g., quantity) of contexts, for all input. This LUT may take an occupancy configuration for a neighborhood of current child cuboid as input and output the context index associated with the occupancy configuration. The LUT may have as many entries as reduced occupancy configurations (e.g., around a few thousand entries). The coding of the occupancy bit of a current child cuboid may comprise steps including determining the reduced occupancy configuration of the current child node, obtaining a context index by using the reduced occupancy configuration as an entry to the LUT, coding the occupancy bit of the current child cuboid by using the context pointed to (or indicated) by the context index, and updating the LUT entry corresponding to the reduced occupancy configuration, for example, based on the value of the coded occupancy bit of the current child cuboid. The LUT entry may be decreased to a lower context index value, for example, if a binary “0” (e.g., indicating the current child cuboid is unoccupied) is coded. The LUT entry may be increased to a higher context index value, for example, if a binary “1” (e.g., indicating the current child cuboid is occupied) is coded. The update process of the context index may be, for example, based on a theoretical model of optimal distribution for virtual probabilities associated with the limited number (e.g., quantity) of contexts. This virtual probability may be fixed by a model and may be different from the internal probability of the context that may evolve, for example, if the coding of bits of data occurs. The evolution of the internal context may follow a well-known process similar to the process in CABAC.

An encoder and/or a decoder may implement a “dynamic OBUF” scheme. The “dynamic OBUF” scheme may enable an encoder and/or a decoder to handle a much larger number (e.g., quantity) of occupancy configurations for a neighborhood of a current child cuboid, for example, than general OBUF. The use of a larger number (e.g., quantity) of occupancy configurations for a neighborhood of a current child cuboid may lead to improved compression capabilities, and may maintain complexity within reasonable bounds. By using an occupancy tree compressed by OBUF, an encoder and/or a decoder may reach a lossless compression performance as good as 1 bit per point (bpp) for coding the geometry of dense point clouds. An encoder and/or a decoder may implement dynamic OBUF to potentially further reduce the bit rate by more than 25% to 0.7 bpp.

OBUF may not take as input a large variety of reduced occupancy configurations for a neighborhood of a current child cuboid, and may potentially cause a loss of useful correlation. With OBUF, the size of the LUT of context indices may be increased to handle more various occupancy configurations for a neighborhood of a current child cuboid as input. Due to such increase, statistics may be diluted, and compression performance may be worsened. For example, if the LUT has millions of entries and the point cloud has a hundred thousand points, then most of the entries may be never visited (e.g., looked up, accessed, etc.). Many entries may be visited only a few times and their associated context index may not be updated enough times to reflect any meaningful correlation between the occupancy configuration value and the probability of occupancy of the current child cuboid. Dynamic OBUF may be implemented to mitigate the dilution of statistics due to the increase of the number (e.g., quantity) of occupancy configurations for a neighborhood of a current child cuboid. This mitigation may be performed by a “dynamic reduction” of occupancy configurations in dynamic OBUF.

Dynamic OBUF may add an extra step of reduction of occupancy configurations for a neighborhood of a current child cuboid, for example, before using the LUT of context indices. This step may be called a dynamic reduction because it evolves, for example, based on the progress of the coding of the point cloud or, more precisely, based on already visited (e.g., looked up in the LUT) occupancy configurations.

As discussed herein, many possible occupancy configurations for a neighborhood of a current child cuboid may be potentially involved but only a subset may be visited if the coding of a point cloud occurs. This subset may characterize the type of the point cloud. For example, most of the visited occupancy configurations may exhibit occupied adjacent cuboids of a current child cuboid, for example, if AR or VR dense point clouds are being coded. On the other hand, most of the visited occupancy configurations may exhibit only a few occupied adjacent cuboids of a current child cuboid, for example, if sensor-acquired sparse point clouds are being coded. The role of the dynamic reduction may be to obtain a more precise correlation, for example, based on the most visited occupancy configuration while putting aside (e.g., reducing aggressively) other occupancy configurations that are much less visited. The dynamic reduction may be updated on-the-fly. The dynamic reduction may be updated on-the-fly, for example, after each visit (e.g., a lookup in the LUT) of an occupancy configuration, for example, if the coding of occupancy data occurs.

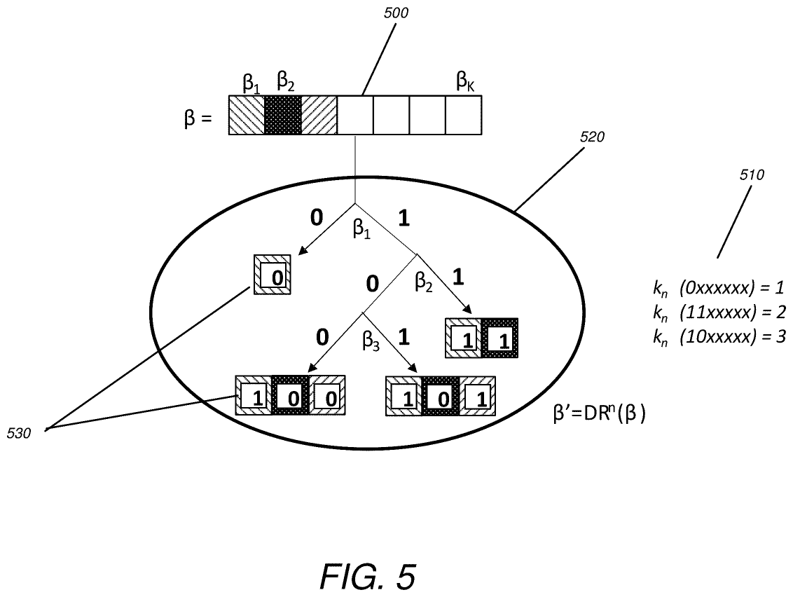

FIG. 5 shows an example of a dynamic reduction function DR that may be used in dynamic OBUF. The dynamic reduction function DR may be obtained by masking bits βⱼ of occupancy configurations 500

β=β₁ . . . β_{K}

made of K bits. The size of the mask may decrease, for example, if occupancy configurations are visited (e.g., looked up in the LUT) a certain number (e.g., quantity) of times. The initial dynamic reduction function DR⁰ may mask all bits for all occupancy configurations such that it is a constant function DR⁰(β)=0 for all occupancy configurations β. The dynamic reduction function may evolve from a function DRⁿ to an updated function DRⁿ⁺¹. The dynamic reduction function may evolve from a function DRⁿ to an updated function DRⁿ⁺¹, for example, after each coding of an occupancy bit. The function may be defined by

β′=DRⁿ(β)=β₁ . . . β_{kn(β)}

where kₙ(β) 510 is the number (e.g., quantity) of non-masked bits. The initialization of DR⁰ may correspond to k₀(β)=0, and the natural evolution of the reduction function toward finer statistics may lead to an increasing number (e.g., quantity) of non-masked bits kₙ(β)≤kₙ₊₁(β). The dynamic reduction function may be entirely determined by the values of kₙ for all occupancy configurations β.

The visits (e.g., instances of a lookup in the LUT) to occupancy configurations may be tracked by a variable NV(β′) for all dynamically reduced occupancy configurations β′=DRⁿ(β). The corresponding number (e.g., quantity) of visits NV(β^{V}′) may be increased by one, for example, after each instance of coding of an occupancy bit based on an occupancy configuration β^{V}. If this number (e.g., quantity) of visits NV(β^{V}′) is greater than a threshold th_{V},

NV(β^{V}′)>th_{V}

then the number (e.g., quantity) of unmasked bits kₙ(β) may be increased by one for all occupancy configurations β being dynamically reduced to β^{V}′. This corresponds to replacing the dynamically reduced occupancy configuration β^{V}′ by the two new dynamically reduced occupancy configurations β⁰′ and β¹′ defined by

β⁰′=β^{V}′0=β^{V}₁ . . . β^{V}_{kn(β)}0 and β¹′=β^{V}′1=β^{V}₁ . . . β^{V}_{kn(β)}1.

In other words, the number (e.g., quantity) of unmasked bits has been increased by one kₙ₊₁(β)=kₙ(β)+1 for all occupancy configurations β such that DRⁿ(β)=β^{V}′. The number (e.g., quantity) of visits of the two new dynamically reduced occupancy configurations may be initialized to zero

$$NV ( {β}^{0 ’} ) = NV ( {β}^{1 ’} ) = 0. \qquad ( I )$$

At the start of the coding, the initial number (e.g., quantity) of visits for the initial dynamic reduction function DR⁰ may be set to

NV(DR⁰(β))=NV(0)=0,

and the evolution of NV on dynamically reduced occupancy configurations may be entirely defined.

The corresponding LUT entry LUT[β^{V}′] may be replaced by the two new entries LUT[β⁰′] and LUT[β¹′] that are initialized by the coder index associated with β^{V}′. The corresponding LUT entry LUT[β^{V}′] may be replaced by the two new entries LUT[β⁰′] and LUT[β¹′] that are initialized by the coder index associated with β^{V}′, for example, if a dynamically reduced occupancy configuration β^{V}′ is replaced by the two new dynamically reduced occupancy configurations β⁰′ and β¹′,

$$LUT [ {β}^{0 ’} ] = LUT [ {β}^{1 ’} ] = L U T [ {β}^{V ’} ] , \qquad ( II )$$

and then evolve separately. The evolution of the LUT of coder indices on dynamically reduced occupancy configurations may be entirely defined.

The reduction function DRⁿ may be modeled by a series of growing binary trees Tⁿ 520 whose leaf nodes 530 are the reduced occupancy configurations β′=DRⁿ(B). The initial tree may be the single root node associated with 0=DR⁰(β). The replacement of the dynamically reduced to β^{V}′ by β⁰′ and β¹′ may correspond to growing the tree Tⁿ from the leaf node associated with β^{V}′, for example, by attaching to it two new nodes associated with β⁰′ and β¹′. The tree Tⁿ⁺¹ may be obtained by this growth. The number (e.g., quantity) of visits NV and the LUT of context indices may be defined on the leaf nodes and evolve with the growth of the tree through equations (I) and (II).

The practical implementation of dynamic OBUF may be made by the storage of the array NV[β′] and the LUT[β′] of context indices, as well as the trees Tⁿ 520. An alternative to the storage of the trees may be to store the array kₙ[β] 510 of the number (e.g., quantity) of non-masked bits.

A limitation for implementing dynamic OBUF may be its memory footprint. In some applications, a few million occupancy configurations may be practically handled, leading to about 20 bits βᵢ constituting an entry configuration B to the reduction function DR. Each bit βᵢ may correspond to the occupancy status of a neighboring cuboid of a current child cuboid or a set of neighboring cuboids of a current child cuboid.

Higher (e.g., more significant) bits βᵢ (e.g., β₀, β₁, etc.) may be the first bits to be unmasked. Higher (e.g., more significant) bits βᵢ (e.g., β₀, β₁, etc.) may be the first bits to be unmasked, for example, during the evolution of the dynamic reduction function DR. The order of neighbor-based information put in the bits βᵢ may impact the compression performance. Neighboring information may be ordered from higher (e.g., highest) priority to lower priority and put in this order into the bits Bi, from higher to lower weight. The priority may be, from the most important to the least important, occupancy of sets of adjacent neighboring child cuboids, then occupancy of adjacent neighboring child cuboids, then occupancy of adjacent neighboring parent cuboids, then occupancy of non-adjacent neighboring child nodes, and finally occupancy of non-adjacent neighboring parent nodes. Adjacent nodes sharing a face with the current child node may also have higher priority than adjacent nodes sharing an edge (but not sharing a face) with the current child node. Adjacent nodes sharing an edge with the current child node may have higher priority than adjacent nodes sharing only a vertex with the current child node.

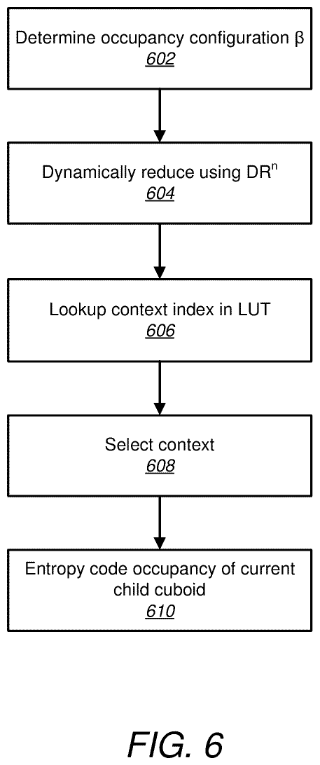

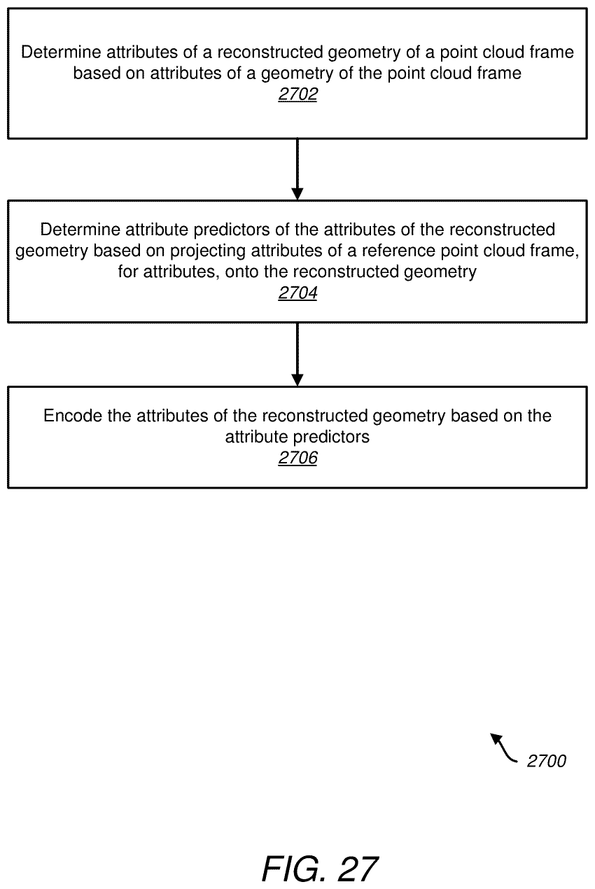

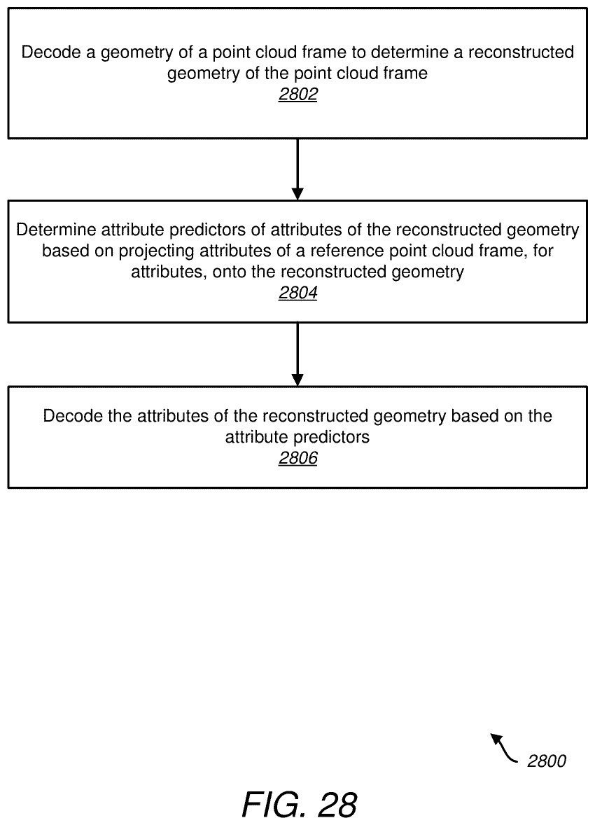

FIG. 6 shows an example method for coding occupancy of a cuboid using dynamic OBUF. More specifically, FIG. 6 shows an example method for coding occupancy bit of a current child cuboid using dynamic OBUF. One or more steps of FIG. 6 may be performed by an encoder and/or a decoder (e.g., the encoder 114 and/or decoder 120 in FIG. 1). All or portions of the flowchart may be implemented by a coder (e.g., the encoder 114 and/or decoder 120 in FIG. 1), an example computer system 2700 in FIG. 27, and/or an example computing device 2830 in FIG. 28.

At step 602, an occupancy configuration (e.g., occupancy configuration β) of the current child cuboid may be determined. The occupancy configuration (e.g., occupancy configuration β) of the current child cuboid may be determined, for example, based on occupancy bits of already-coded cuboids in a neighborhood of the current child cuboid. At step 604, the occupancy configuration (e.g., occupancy configuration β) may be dynamically reduced. The occupancy configuration may be dynamically reduced, for example, using a dynamic reduction function DRⁿ. For example, the occupancy configuration β may be dynamically reduced into a reduced occupancy configuration β′=DRⁿ(β). At step 606, context index may be looked up, for example, in a look-up table (LUT). For example, the encoder and/or decoder may look up context index LUT[β′] in the LUT of the dynamic OBUF. At step 608, context (e.g., probability model) may be selected. For example, the context (e.g., probability model) pointed to by the context index may be selected. At step 610, occupancy of the current child cuboid may be entropy coded. For example, the occupancy bit of the current child cuboid may be entropy coded (e.g., arithmetic coded), for example, based on the context. The occupancy bit of the current child cuboid may be coded based on the occupancy bits of the already-coded cuboids neighboring the current child cuboid.

Although not shown in FIG. 6, the encoder and/or decoder may update the reduction function and/or update the context index. For example, the encoder and/or decoder may update the reduction function DRⁿ into DRⁿ⁺¹ and/or update the context index LUT[β′], for example, based on the occupancy bit of the current child cuboid. The method of FIG. 6 may be repeated for additional or all child cuboids of parent cuboids corresponding to nodes of the occupancy tree in a scan order, such as the scan order discussed herein with respect to FIG. 3.

In general, the occupancy tree is a lossless compression technique. The occupancy tree may be adapted to provide lossy compression, for example, by modifying the point cloud on the encoder side (e.g., down-sampling, removing points, moving points, etc.). The performance of the lossy compression may be weak. The lossy compression may be a useful lossless compression technique for dense point clouds.

One approach to lossy compression for point cloud geometry may be to set the maximum depth of the occupancy tree to not reach the smallest volume size of one voxel but instead to stop at a bigger volume size (e.g., N×N×N cuboids (e.g., cubes), where N>1). The geometry of the points belonging to each occupied leaf node associated with the bigger volumes may then be modeled. This approach may be particularly suited for dense and smooth point clouds that may be locally modeled by smooth functions such as planes or polynomials. The coding cost may become the cost of the occupancy tree plus the cost of the local model in each of the occupied leaf nodes.

A scheme for modeling the geometry of the points belonging to each occupied leaf node associated with a volume size larger than one voxel may use sets of triangles as local models. The scheme may be referred to as the “TriSoup” scheme. TriSoup is short for “Triangle Soup” because the connectivity between triangles may not be part of the models. An occupied leaf node of an occupancy tree that corresponds to a cuboid with a volume greater than one voxel may be referred to as a TriSoup node. An edge belonging to at least one cuboid corresponding to a TriSoup node may be referred to as a TriSoup edge. A TriSoup node may comprise a presence flag (sₖ) for each TriSoup edge of its corresponding occupied cuboid. A presence flag (sₖ) of a TriSoup edge may indicate whether a TriSoup vertex (Vₖ) is present or not on the TriSoup edge. At most one TriSoup vertex (Vₖ) may be present on a TriSoup edge. For each vertex (Vₖ) present on a TriSoup edge of an occupied cuboid, the TriSoup node corresponding to the occupied cuboid may comprise a position (pₖ) of the vertex (Vₖ) along the TriSoup edge.

In addition to the occupancy words of an occupancy tree, an encoder may entropy encode, for each TriSoup node of the occupancy tree, the TriSoup vertex presence flags and positions of each TriSoup edge belonging to TriSoup nodes of the occupancy tree. A decoder may similarly entropy decode the TriSoup vertex presence flags and positions of each TriSoup edge and vertex along a respective TriSoup edge belonging to a TriSoup node of the occupancy tree, in addition to the occupancy words of the occupancy tree.

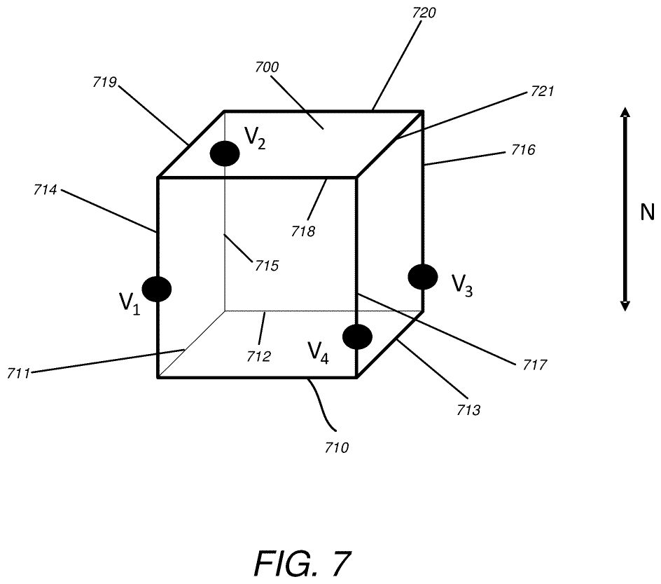

FIG. 7 shows an example of an occupied cuboid (e.g., cube) 700. More specifically, FIG. 7 shows an example of an occupied cuboid (e.g., cube) 700 of size N×N×N (where N>1) that corresponds to a TriSoup node of an occupancy tree. An occupied cuboid 700 may comprise edges (e.g., TriSoup edges 710-721). The TriSoup node, corresponding to the occupied cuboid 700, may comprise a presence flag (sₖ) for each edge (e.g., each TriSoup edge of the TriSoup edges 710-721). For example, the presence flag of a TriSoup edge 714 may indicate that a TriSoup vertex V₁ is present on the TriSoup edge 714. The presence flag of a TriSoup edge 715 may indicate that a TriSoup vertex V₂ is present on the TriSoup edge 715. The presence flag of a TriSoup edge 716 may indicate that a TriSoup vertex V₃ is present on the TriSoup edge 716. The presence flag of a TriSoup edge 717 may indicate that a TriSoup vertex V₄ is present on the TriSoup edge 717. The presence flags of the remaining TriSoup edges each may indicate that a TriSoup vertex is not present on their corresponding TriSoup edge. The TriSoup node, corresponding to the occupied cuboid 700, may comprise a position for each TriSoup vertex present along one of its TriSoup edges 710-721. More specifically, the TriSoup node, corresponding to the occupied cuboid 700, may comprise a position p₁ for TriSoup vertex V₁, a position p₂ for TriSoup vertex V₂, a position p₃ for TriSoup vertex V₃, and a position p₄ for TriSoup vertex V₄. The TriSoup vertices may be shared among TriSoup nodes along common TriSoup edge(s).

A presence flag (sₖ) and, if the presence flag (sₖ) may indicate the presence of a vertex, a position (pₖ) of a current TriSoup edge may be entropy coded. The presence flag (sₖ) and position (pₖ) may be individually or collectively referred to as vertex information or TriSoup vertex information. A presence flag (sₖ) and, if the presence flag (sₖ) indicates the presence of a vertex, a position (pₖ) of a current TriSoup edge may be entropy coded, for example, based on already-coded presence flags and positions, of present TriSoup vertices, of TriSoup edges that neighbor the current TriSoup edge. A presence flag (sₖ) and, if the presence flag (sₖ) may indicate the presence of a vertex, a position (pₖ) of a current TriSoup edge (e.g., indicating a position of the vertex the edge is along) may be additionally or alternatively entropy coded. The presence flag (sₖ) and the position (pₖ) of a current TriSoup edge may be additionally or alternatively entropy coded, for example, based on occupancies of cuboids that neighbor the current TriSoup edge. Similar to the entropy coding of the occupancy bits of the occupancy tree, a configuration β_{TS} for a neighborhood (also referred to as a neighborhood configuration β_{TS}) of a current TriSoup edge may be obtained and dynamically reduced into a reduced configuration β_{TS}′=DRⁿ(β_{TS}), for example, by using a dynamic OBUF scheme for TriSoup. A context index LUT[β_{TS}′] may be obtained from the OBUF LUT. At least a part of the vertex information of the current TriSoup edge may be entropy coded using the context (e.g., probability model) pointed to by the context index.

The TriSoup vertex position (pₖ) (if present) along its TriSoup edge may be binarized. The TriSoup vertex position (pₖ) (if present) along its TriSoup edge may be binarized, for example, to use a binary entropy coder to entropy code at least part of the vertex information of the current TriSoup edge. A number (e.g., quantity) of bits N_{b} may be set for the quantization of the TriSoup vertex position (pₖ) along the TriSoup edge of length N. The TriSoup edge of length N may be uniformly divided into 2^{Nb} quantization intervals. By doing so, the TriSoup vertex position (pₖ) may be represented by N_{b} bits (pₖ^{j}, j=1, . . . , N_{b}) that may be individually coded by the dynamic OBUF scheme as well as the bit corresponding to the presence flag (sₖ). The neighborhood configuration β_{TS}, the OBUF reduction function DRⁿ, and the context index may depend on the nature, characteristic, and/or property of the coded bit (e.g., a presence flag (sₖ), a highest position bit (pₖ₁), a second highest position bit (pₖ₂), etc.) of the coded bit (e.g., presence flag (sₖ), highest position bit (pₖ¹), second highest position bit (pₖ²), etc.). There may practically be several dynamic OBUF schemes, each dedicated to a specific bit of information (e.g., presence flag (sₖ) or position bit (pₖ^{j})) of the vertex information.

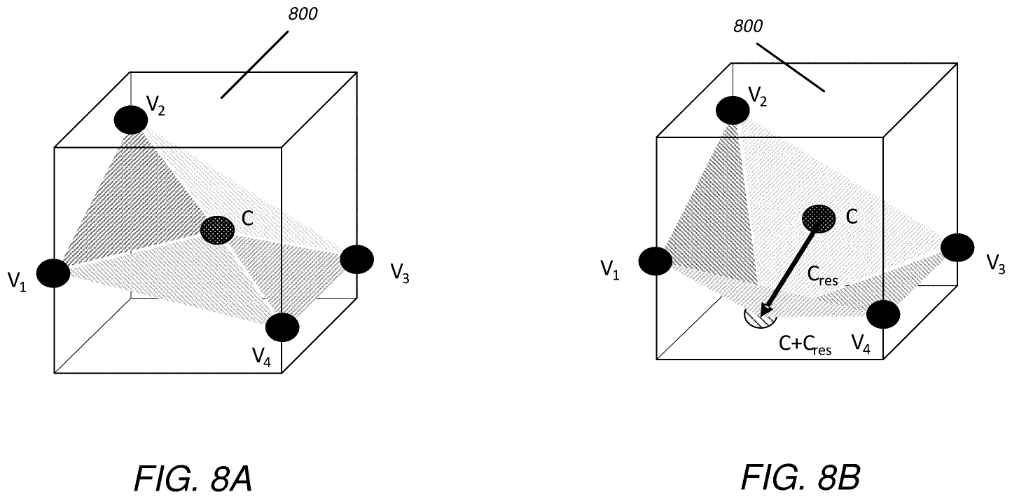

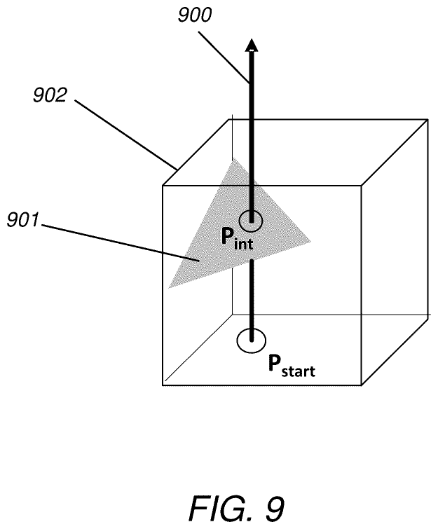

FIG. 8A shows an example cuboid 800 (e.g., a cube) corresponding to a TriSoup node. A cuboid 800 may correspond to a TriSoup node with a number K of TriSoup vertices Vₖ. Within cuboid 800, TriSoup triangles may be constructed from the TriSoup vertices Vₖ. TriSoup triangles may be constructed from the TriSoup vertices Vₖ, for example, if at least three (K≥3) TriSoup vertices are present on the TriSoup edges of cuboid 800. For example, with respect to FIG. 8A, four TriSoup vertices may be present and TriSoup triangles may be constructed. The TriSoup triangles may be constructed around the centroid vertex C defined as the mean of the TriSoup vertices Vₖ. A dominant direction may be determined, then vertices Vₖ may be ordered by turning around this direction, and the following K TriSoup triangles (listed as triples of vertices) may be constructed: V₁V₂C, V₂V₃C, . . . , V_{K}V₁C. The dominant direction may be chosen among the three directions respectively parallel to the axes of the 3D space to increase or maximize the 2D surface of the triangles, for example, if the triangles are projected along the dominant direction. By doing so, the dominant direction may be somewhat perpendicular to a local surface defined by the points of the point cloud belonging to the TriSoup node.

FIG. 8B shows an example refinement to the TriSoup model. The TriSoup model may be refined by coding a centroid residual value. A centroid residual value Cᵣₑₛ may be coded into the bitstream. A centroid residual value Cᵣₑₛ may be coded into the bitstream, for example, to use C+Cᵣₑₛ instead of C as a pivoting vertex for the triangles. By using C+Cᵣₑₛ as the pivoting vertex for the triangles, the vertex C+Cᵣₑₛ may be closer to the points of the point cloud than the centroid C, the reconstruction error may be lowered, leading to lower distortion at the cost of a small increase in bitrate needed for coding Cᵣₑₛ.

The reconstruction of a decoded point cloud from a set of TriSoup triangles may be referred to as “voxelization” and may be performed, for example, by ray tracing or rasterization, for each triangle individually before duplicate voxels from the voxelized triangles are removed.

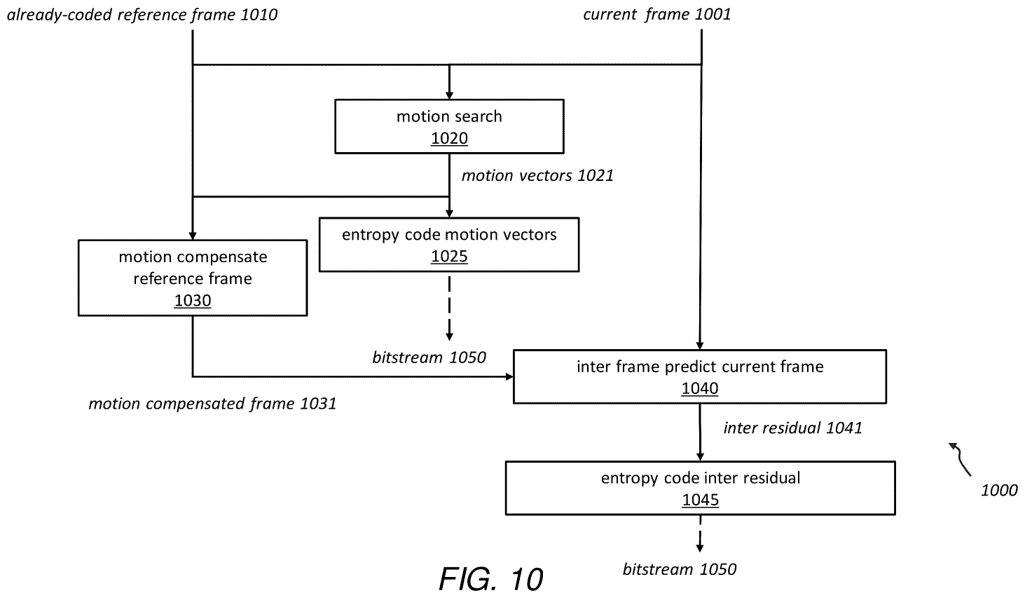

FIG. 9 shows an example of voxelization. Rays 900 may be launched parallel to one of the three axes of the 3D space, starting from integer coordinates Pₛₜₐᵣₜ. The intersection Pᵢₙₜ, if any, with a TriSoup triangle 901 belonging to a cube 902 may be rounded to determine a decoded point. The cube 902 may correspond to a TriSoup node. The intersection may be found (e.g., determined), for example, using the Möller-Trumbore algorithm.

A presence flag (sₖ) and, if the presence flag (sₖ) indicates the presence of a vertex, a position (pₖ) of the vertex along a current TriSoup edge may be entropy coded, for example, based on already-coded presence flags and positions (of present TriSoup vertices) of TriSoup edges that neighbor the current TriSoup edge. The presence flag (sₖ) and position (pₖ), individually or collectively, may be referred to as vertex information. A presence flag (sₖ) and, if the presence flag (sₖ) indicates the presence of a vertex, a position (pₖ) on (e.g., indicating a position of the vertex along) a current TriSoup edge may be additionally or alternatively entropy coded, for example, based on occupancies of cuboids that neighbor the current TriSoup edge. Similar to the entropy coding of the occupancy bits of the occupancy tree, a configuration β_{TS} for a neighborhood (also referred to as a neighborhood configuration β_{TS}) of a current TriSoup edge may be determined and/or dynamically reduced into a reduced configuration β_{TS}′=DRⁿ(β_{TS}), for example, by using a dynamic OBUF scheme for TriSoup. A context index LUT[β_{TS}′] may be determined from the OBUF LUT. At least a part of the vertex information of the current TriSoup edge may be entropy coded, for example, using the context (or probability model) pointed to by the context index.

The TriSoup vertex position (pₖ) (if present) along its TriSoup edge may be binarized. A binary entropy coder may entropy code at least part of the vertex information of the current TriSoup edge. A number of bits N_{b} may be set for the quantization of the TriSoup vertex position (pₖ) along the TriSoup edge of length N that is uniformly divided into 2^{Nb} quantization intervals. The TriSoup vertex position (pₖ) may be represented by N_{b} bits (pₖ^{j}, j=1, . . . , N_{b}), for example, if the number of bits N_{b} is set for the quantization of the TriSoup vertex position (pₖ) along the TriSoup edge of length N that is uniformly divided into 2^{Nb} quantization intervals. The N_{b} bits, as well as the bit corresponding to the presence flag (sₖ), may be individually coded by the dynamic OBUF scheme. The neighborhood configuration β_{TS}, the OBUF reduction function DRⁿ, and/or the context index may depend on the nature/characteristic/property of the coded bit (e.g., presence flag (sₖ), highest position bit (pₖ¹), or second highest position bit (pₖ²)). Several dynamic OBUF schemes may be implemented, with each dedicated to a specific bit of information (e.g., presence flag (sₖ) or position bit (pₖ^{j})) of the vertex information.

In video compression, performance may be improved by using inter frame prediction. Bitrates for compressing interframes may be one to two orders of magnitude lower than bitrates of intra frames, which may not use inter frame prediction. Point cloud data may behave differently from, for example, 2D video data. The 3D geometry, for point cloud data, may be coded by 3D point positions. Each point position of the 3D point positions may be associated with attributes (e.g., colors). Geometry and/or attributes may change between frames. Different 3D point positions and/or attributes associated with the corresponding 3D point positions may be coded, for example, for each frame. 2D video data may obtained, for example, by the projection of the 3D geometry and/or attributes onto a 2D plane having a fixed geometry (e.g., a camera sensor). For video coding, the attributes may be coded but the geometry may not be coded (and may not need to be coded). It may be expected that inter frame prediction between 3D point clouds may provide improved compression capability as compared to intra frame prediction (e.g., intra frame prediction alone) within a point cloud, even if, for example, 2D-projected attributes are expected to temporally have a higher correlation than the underlying 3D geometry. The octree may benefit from inter frame prediction and/or geometry compression gains. The general framework of inter frame prediction for 3D point clouds may be similar to the one of video compression.

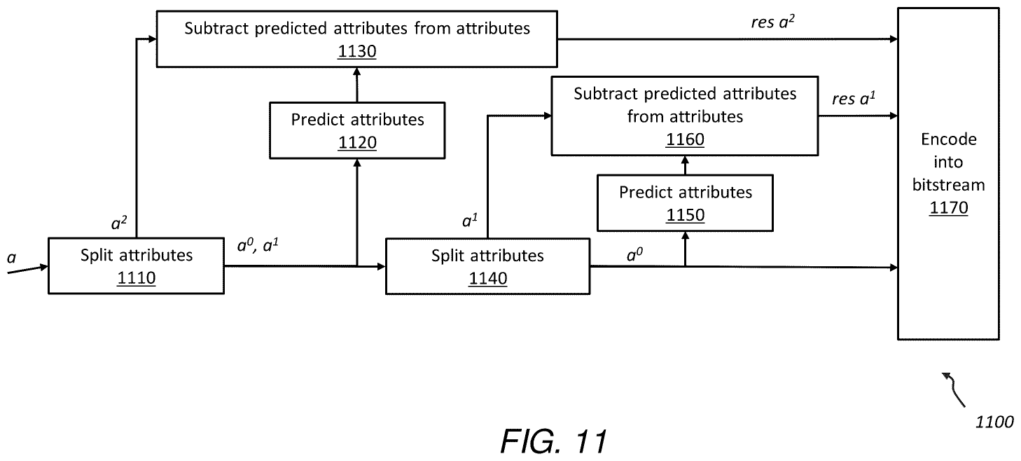

FIG. 10 shows an example encoding method 1000. One or more steps of FIG. 10 may be performed by an encoder (e.g., the encoder 114). Encoding method 1000 may use inter frame prediction between different point cloud frames. A current frame 1001 (e.g., an image or a point cloud) may be coded relative to an already-coded reference frame 1010 (e.g., an image or a point cloud). At step 1020, a motion search may be performed from the already-coded reference frame 1010 toward the current frame 1001 to determine motion vectors 1021 that represents a motion flow between the two frames 1010 and 1001. In video compression, motion vectors may be 2-component (or 2D) vectors representing the motion from reference blocks of pixels to current blocks of pixels. In point cloud compression, motion vectors may be 3-component (or 3D) vectors representing the motion from reference sets of 3D points (e.g., in a reference point cloud) to current sets of 3D points (e.g., in a current point cloud). At step 1025, motion vectors 1021 may be entropy coded into bitstream 1050. At step 1030, the reference frame 1010 may be motion compensated to determine a motion compensated frame 1031. Motion compensation may involve moving the pixels of the reference image based on the 2D (motion vectors, and/or moving the points of the reference point cloud based on the 3D motion vectors. The determined motion compensated frame may be “closer” to the current frame than the reference frame, for example, the color difference (or point distance) between the motion compensated frame 1031 and the current frame 1001 may be, on average, smaller than the color difference (or point distance) between the reference frame 1010 and the current frame 1001. At step 1040, inter frame prediction may be performed to determine inter residuals 1041. At step 1045, the inter residuals 1040 may be entropy coded into bitstream 1050. The inter residuals may carry more compressible information than the current frame that may or may not have undergone an intra prediction process. Therefore, the entropy coding performed at step 1045 may be more efficient for determining a bitstream 1050 with reduced size, compared to a bitstream determined by coding the current frame 1001 that has not benefited from inter frame prediction.

In video coding, inter residuals may be constructed as the difference of colors, pixel per pixel, between a current block of pixels belonging to the current frame (e.g., image) and a co-located compensated block of pixels belonging to the motion compensated frame (e.g., image). Inter residuals may be arrays of color differences that have typically small magnitude and may be efficiently compressed.

In point cloud compression, there may not be a “difference” between two sets of points, because there may not be a one-to-one mapping of the two sets of points. The concept of an inter residual may not be straightforwardly used (e.g., generalized) with respect to point clouds. For prediction of an octree representing a point cloud, the concept of inter residual may be replaced by conditional entropy coding, where conditional information for performing conditional entropy coding may be constructed based on a motion compensated point cloud. This may be extended to the framework of dynamic OBUF.

As described herein, the occupancy of a current volume (e.g., the current volume associated with a current node of an octree) may be provided by a quantity of occupancy bits, e.g., 8 occupancy bits. A current occupancy bit of the octree may be coded by an entropy coder selected by the output of a dynamic OBUF LUT of coder indices that takes a neighborhood configuration β as input. The neighborhood configuration β may be constructed based on already-coded occupancy bits. The already-coded occupancy bits may be associated with neighboring volumes (e.g., associated with neighboring nodes of the current node). The construction of the neighborhood configuration β may be extended using inter frame information. An inter predictor occupancy bit may be indicated by (e.g., defined for) a current occupancy bit as a bit representative of the presence of at least one point of a motion compensated point cloud within the current volume. A strong correlation between the current occupancy bit and the inter predictor occupancy bit may exist, for example, if that motion compensation is efficient. This may be because the current and motion compensated point clouds are likely close to each other. Using the inter predictor occupancy bit as a bit of the neighborhood configuration β may lead to better compression performance of the octree (e.g., dividing the size of the octree bitstream by a factor two).

The motion field between octrees may comprise 3D motion vectors associated with 3D prediction units (PU). The PUs may have volumes that may include at least a part of one or several volumes (e.g., cuboids) associated with nodes of the octree. The motion compensation may be performed volume per volume (e.g., cuboid per cuboid) based on the 3D motion vectors for determining a motion compensated point cloud in one or more current volumes. The inter predictor occupancy bit may be determined, for example, based on the presence of at least one point of this motion compensated point cloud.

The TriSoup scheme may benefit from the motion compensated frame determined while the octree coding is performed, for example, before the TriSoup coding. Predictors of the presence and/or position of TriSoup vertices may be determined based on the motion compensated point cloud. The predictors may be determined, for example, based on the intersection of the compensated point cloud with the edges of the TriSoup nodes. Predictors of the centroid residual values may be determined.

The entropy coding of TriSoup vertices and/or centroid residual values may be performed, for example, by using these inter predictors. Inter predictors may constitute a part of a contextual information βᵢₙₜₑᵣ input of a dynamic OBUF instance that codes a TriSoup syntax element. Alternatively or additionally, a context may be selected based on inter predictors. The selected context may be used by an entropy coder (e.g., CABAC) to determine a probability for arithmetically entropy coding of a TriSoup syntax element.

Attributes associated with points of a point cloud may be coded, for example, after the coding of the underlying geometry (e.g., the positions of the points in the 3D space) has been performed. If the geometry coding is a lossless coding (e.g., by using an octree scheme), the encoder may have direct access to the attribute values associated with the coded points. The coded geometry may differ from the original geometry, for example, if the geometry coding is a lossy coding (e.g., by using a TriSoup scheme). The original attributes may be mapped by the encoder from the original geometry to the coded geometry for determining mapped attributes on the coded geometry.

As described herein, attributes may indicate a property of a point's visual appearance (e.g., texture, color, material, transparency, reflectance, time stamp, or velocity). For attributes that are colors, the attribute mapping performed by the encoder may be referred to as a recoloring process. This may be because the colors of the original geometry may be used to color (e.g., recolor) the coded geometry (e.g., a reconstructed geometry).

The coded geometry associated with the mapped attributes for the coded geometry may comprise a point cloud representative of the original point cloud in geometry and attributes. There may be more than one (e.g., two) attribute coding schemes that may be used and/or selected for coding attributes associated with the coded geometry. The attribute coding schemes may comprise, for example, the prediction with lifting transform (“pred-lift”) scheme, and/or the region-adaptive hierarchical transform (“RAHT”) scheme. The attribute coding schemes may be used, for example, in G-PCC.

The pred-lift scheme first may perform a decomposition of the coded geometry into Levels of Details (also known as LoD). For a set(S) of points (e.g., all points) of the coded geometry, the set may be decomposed into disjoint subsets Sⁱ such that S=Uᵢ₌₀^{L-1}Sⁱ. L levels of details may be defined as a tower of point cloud geometries

$${S}^{0} ⊂ {S}^{0} ∪ {S}^{1} ⊂ ⋯ ⊂ {S}^{0} ∪ … ∪ {S}^{L - 1} = S$$

where the set S⁰ of points may be the first (e.g., coarsest) level of details, and the set S⁰∪ . . . ∪S^{L-1} of points may be the L^{th} (e.g., finest) level of details, for example, if the set may be decomposed into disjoint subsets Sⁱ such that S=Uᵢ₌₀^{L-1}Sⁱ.

Attributes aⱼ may be associated with the points sⱼ of the set S of all points of the coded geometry. Considering subsets a⁰, . . . , a^{L-1} of attributes, attributes aⁱⱼ of a subset aⁱ may be associated with the points sⁱⱼ of the subset Sⁱ. The i^{th} level of details (S⁰∪ . . . ∪Sⁱ⁻¹) may have associated attributes comprising the concatenation of attributes of subsets a⁰, . . . , aⁱ⁻¹ The set ‘a’ of attributes (e.g., all attributes) may be partitioned into subsets a⁰, . . . , a^{L-1}.

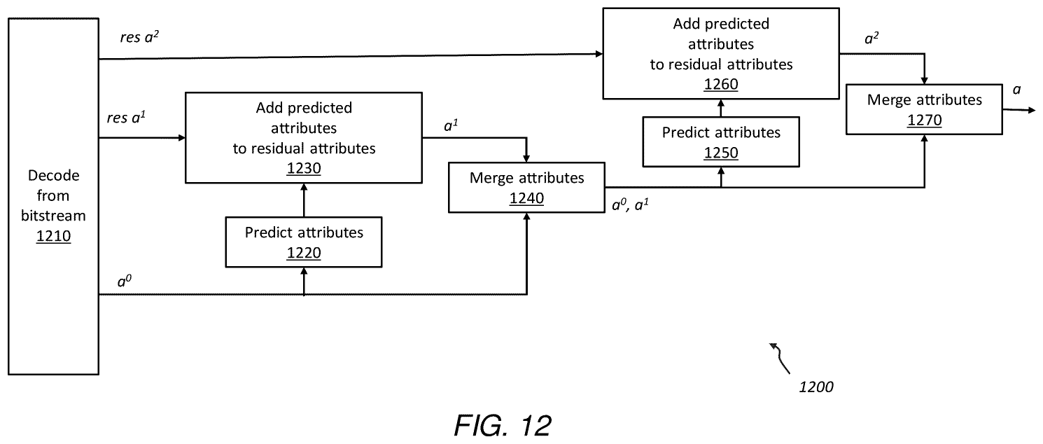

FIGS. 11, 12, 13, and 14 show examples for coding (e.g., encoding or decoding) point cloud attributes. The coding may be based on intra transform schemes such as a prediction transform scheme or a pred-lift scheme. The prediction transform scheme may be a variation of pred-lift scheme without update operations. The intra transform schemes may be examples of wavelet transforms that may convert (e.g., transform) attribute values into wavelet coefficients, which may be more efficiently compressed than the original attribute values. The wavelet coefficients may represent values of residual attributes, which may be smaller and more efficiently compressed than the values of the original attributes. The residual attributes may be referred to as and/or comprise wavelet coefficients (or transform/transformed coefficients). The wavelet coefficients may result from application of the prediction transform scheme and/or pred-lift scheme.

As described herein, the prediction transform scheme and/or pred-lift scheme may operate using prediction for and/or between levels of details of attributes. At the encoder, attributes at a higher (e.g., finer) level of detail may be predicted based on attributes at a lower (e.g., coarser) level of detail. Each level of detail starting from the highest level may be successively predicted, for example, based on lower level(s) of detail. The decoder may perform inverse operations such that attributes at a lower level of detail may be predicted and/or reconstructed, for example, based on residual attributes of higher level(s) of detail. Each level of detail starting from the lowest level may be successively predicted and reconstructed, for example, based on higher level(s) of detail. Although the examples shown in FIGS. 11-14 show three levels of details (LoDs), it is appreciated that a different number of LoDs may be used, for example, by extending (e.g., iteratively) the decomposition scheme.

FIG. 11 shows an example method for encoding point cloud attributes. The encoding may be based on a prediction transform scheme. One or more steps of FIG. 11 may be performed by an encoder (e.g., the encoder 114 in FIG. 1).

A set ‘a’ of attributes may be coded, for example, using prediction for and between one or more (e.g., three) levels of details, from a highest (e.g., first predicted) level of details (e.g., associated with highest frequencies such as res a²) to a lowest (e.g., third) level of details (e.g., associated with lowest frequencies such as a⁰). At step 1110, an encoder may split a set ‘a’ of attributes into a first set of attributes comprising the attributes of the subset a² and a second set of attributes comprising the attributes of the two subsets a⁰ and a¹. At step 1120, the encoder may determine predictive values of the attributes of the first set of attributes (a²) from the attributes of the second set of attributes (a⁰ and a¹). At step 1130, the encoder may determine first residual values ‘res a²’. The encoder may determine first residual values ‘res a²’, for example, by subtracting the predictive values from the attributes of the first set of attributes (a²). At step 1170, the encoder may encode the first residual values ‘res a²’ into the bitstream. The operations at steps 1120-1130 may be iteratively used for (e.g., applied to) each successively lower (e.g., coarser) LoD.

At step 1140, the encoder may split the second set of attributes (a⁰ and a¹) into a third set of attributes and a fourth set of attributes. The third set of attributes may comprise the attributes of the subsets a¹. The fourth set of attributes may comprise the attributes of the subset a⁰. At step 1150, the encoder may determine predictive values of the attributes of the third set of attributes (a¹) from the attributes of the fourth set of attributes (a⁰). At step 1160, the encoder may determine second residual values ‘res a¹’. The encoder may determine second residual values ‘res a¹’, for example, by subtracting predictive values from the attributes of the third set (a¹). At step 1170, the encoder may encode the second residual values ‘res a¹’ into the bitstream. The encoder may encode the attributes of the fourth set of attributes (a⁰) into the bitstream.

The bitstream may comprise data representative of first residual values ‘res a²’, second residual values ‘res a¹’, and/or the attributes of the subset a⁰ (e.g., the fourth set of attributes). At step 1170, the residual values may be entropy coded. The encoder may encode the attributes of the subset a⁰ into the bitstream. Additionally or alternatively, the encoder may perform intra prediction of a current attribute a⁰ⱼ of the subset a⁰ to be coded. The encoder may perform intra prediction of a current attribute a⁰ⱼ of the subset a⁰ to be coded, for example, based on already-coded attributes of the subset a⁰. This may improve the compression efficiency of the attributes of the subset a⁰.

The encoder may quantize the attributes of the subset a⁰, the first residual value ‘res a²’, and/or the second residual value ‘res a¹’, for example, if lossy attribute coding is allowed. The encoder may encode (e.g., entropy encode), into the bitstream, the attributes of the subset a⁰ (or the quantized attributes of the subset a⁰), the first residual value ‘res a²’ (or the quantized first residual values ‘res a²’), and/or the second residual value ‘res a¹’ (or the quantized second residual value ‘res a¹’).

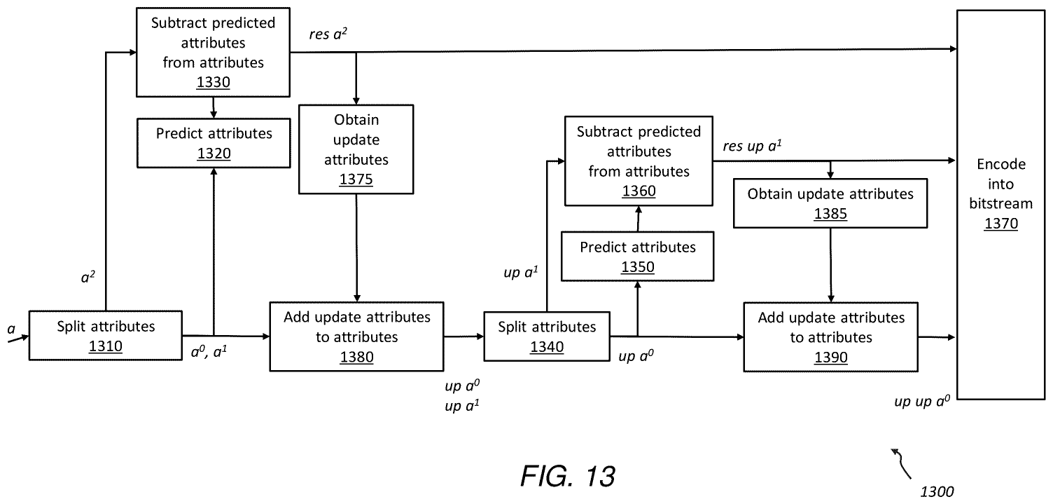

FIG. 12 shows an example method for decoding point cloud attributes. The decoding may be based on a prediction transform scheme. One or more steps of FIG. 12 may be performed by a decoder (e.g., the decoder 120 in FIG. 1). A set ‘a’ of attributes may be decoded. The set of ‘a’ attributes may be encoded, for example, as described herein with respect to FIG. 11. The decoding may use prediction between one or more (e.g., three) levels of details, from a lowest (e.g., third) level of details to a highest (e.g., first) level of details (e.g., in reverse order of the encoder described herein with respect to FIG. 11).

At step 1210, the decoder may decode the first residual values ‘res a²’, the second residual values ‘res a¹’, and/or attributes of a fourth set of attributes (a⁰) from the bitstream. The decoder may use (e.g., apply) dequantization (e.g., for lossy compression). At step 1220, the decoder may determine predictive values of the attributes of a third set of attributes (a¹) from the decoded attributes of the fourth set of attributes (a⁰). The decoder may determine the predictive values, for example, in a way similar to that described with respect to step 1150 of FIG. 11. At step 1230, the decoder may determine decoded attributes of the third set of attributes (a¹), for example, by adding the predictive values to the decoded first residual values ‘res a¹’. The operations at steps 1120-1230 may be iteratively used for (e.g., applied to) each successively higher (e.g., finer) LoD.

At step 1240, the decoder may determine a second set of attributes (a⁰ and a¹). The decoder may determine a second set of attributes (a⁰ and a¹), for example, by merging the third set of attributes (a¹) and the fourth set of attributes (a⁰). Step 1240 may be an inverse of step 1140. At step 1250, the decoder may determine predictive values of the attributes of a first set of attributes (a²) from the attributes of the second set of attributes (a⁰ and a¹). The decoder may determine predictive values in a way similar to that described with respect to step 1120. At step 1260, the decoder may determine decoded attributes of the first set of attributes (a²), for example, by adding the predictive values to the decoded second residual values ‘res a²’. At step 1270, the decoder may determine the set ‘a’ of decoded attributes for the coded geometry S (e.g., the whole coded geometry S), for example, by merging the first set of attributes (a²) and the second set of attributes (a⁰ and a¹). Step 1270 may be an inverse of step 1110.

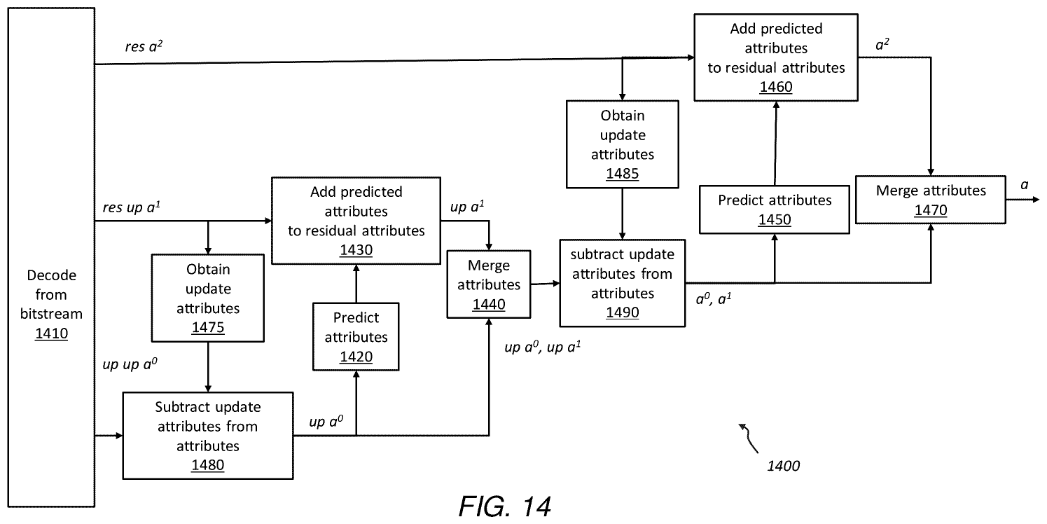

FIG. 13 shows an example method for encoding point cloud attributes. The encoding may be based on a pred-lift transform scheme with prediction and update. One or more steps of FIG. 13 may be performed by an encoder (e.g., the encoder 114 in FIG. 1). A set ‘a’ of attributes may be encoded using prediction between one or more (e.g., three) levels of details, from a highest (e.g., first) level of details (e.g., associated with highest frequencies such as res a²) to a lowest (e.g., third) level of details (e.g., associated with lowest frequencies such as up up a⁰).

At step 1310, an encoder may split a set ‘a’ of attributes into a first set of attributes comprising the attributes of the subset a² and a second set of attributes comprising the attributes of the two subsets a⁰ and a¹. Step 1310 may be performed similar to that described herein with respect to step 1110 of FIG. 11. At step 1320, the encoder may determine predictive values of the attributes of the first set of attributes (a²) from the attributes of the second set of attributes (a⁰ and a¹). Step 1320 may be performed similar to that described herein with respect to step 1120. At step 1330, the encoder may determine first residual values ‘res a²’, for example, by subtracting predictive values from the attributes of the first set of attributes (a²). Step 1320 may be performed similar to that described herein with respect to step 1130. At step 1370, the encoder may encode the first residual values ‘res a²’ into the bitstream. Step 1370 may be performed similar to that described herein with respect to step 1170.

At step 1375, the encoder may determine update attribute values from the first residual values ‘res a²’. The encoder may determine an update attribute value, for example, based on a first residual value. The update attribute value may be determined as the first residual value multiplied by a scaling factor (e.g., ½, ¼, ⅛) that may be predetermined or signaled in the bitstream. At step 1380, the encoder may update attribute values ‘up a⁰’ and ‘up a¹’ of the second set of attributes (a⁰ and a¹) by adding the update attribute values to the attribute values of the second set of attributes (a⁰ and a¹). The operations at steps 1320, 1330, 1375, and 1380 may be iteratively used for (e.g., applied to) each successively lower (e.g., coarser) LoD.

At step 1340, the encoder may split the second set of attributes (a⁰ and a¹) into a third set of attributes and a fourth set of attributes. The third set of attributes may comprise the updated attribute values ‘up a¹’ of the subset a¹. The fourth set of attributes may comprise the updated attribute values ‘up a⁰’ of the subset a⁰. At step 1350, the encoder may determine predictive values of the updated attribute values ‘up a¹’ of the third set of attributes (a¹) from the updated attribute values ‘up a⁰’ of the fourth set of attributes (a⁰). At step 1360, the encoder may determine third residual values ‘res up a¹’, for example, by subtracting predictive values from the updated attribute values ‘up a¹’ of the third set of attributes (a¹). At step 1370, the encoder may encode the third residual values ‘res up a¹’ into the bitstream. At step 1385, the encoder may determine update attribute values from the third residual values ‘res up a¹’. At step 1390, the encoder may determine further updated attribute values ‘up up a⁰’ of the fourth set of attributes (a⁰), for example, by adding the update attribute values to the updated attribute values ‘up a⁰’ of the fourth set of attributes (a⁰). At step 1370, the encoder may encode the further updated attribute values ‘up up a⁰’ of the fourth set of attributes (a⁰) into the bitstream.

The bitstream may comprise data representative of transformed attributes (e.g., data representative of the first residual values ‘res a²’, third residual values ‘res up a¹’ and/or further updated attribute values ‘up up a⁰’ of the fourth set of attributes). The encoder may encode the further updated attribute values ‘up up a⁰’ of the fourth set of attributes into the bitstream. The encoder may perform intra prediction of a current further updated attribute values ‘up up a⁰ⱼ’ to be coded, for example, based on already-coded attributes of the fourth set of attributes. This may improve the compression efficiency of the further updated attribute values ‘up up a⁰’ of the fourth set of attributes.

The encoder may quantize the further updated attribute values ‘up up a⁰’ of the fourth set of attributes, the first residual value ‘res a²’ and/or the third residual value ‘res up a¹’, for example, if lossy attribute coding is allowed. The encoder may entropy encode into the bitstream the further updated attribute values ‘up up a⁰’ of the fourth set of attributes, the first residual value ‘res a²’ (or the quantized first residual values ‘res a²’), and/or the third residual value ‘res up a¹’ (or the quantized third residual value ‘res up a¹’).

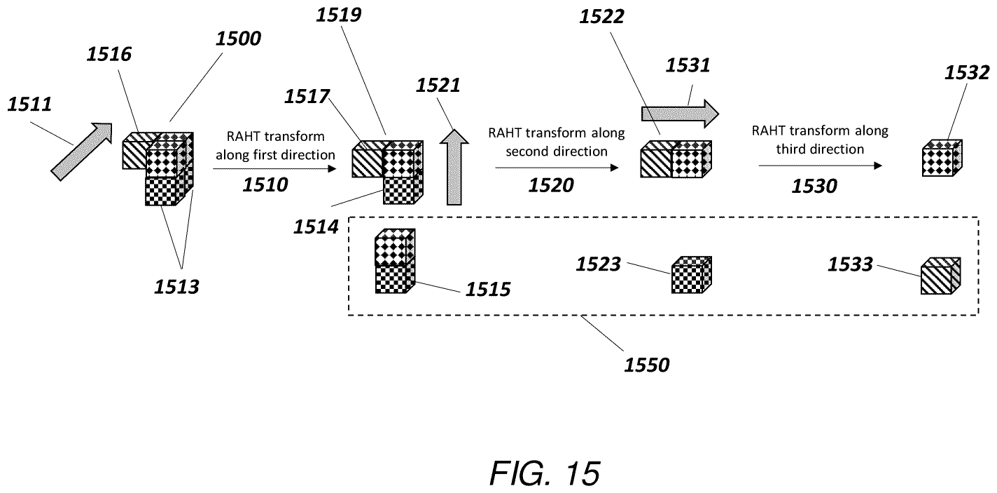

FIG. 14 shows an example method for decoding point cloud attributes. The decoding may be based on a pred-lift transform scheme with prediction and update. One or more steps of FIG. 14 may be performed by a decoder (e.g., the decoder 120 in FIG. 1). A set of ‘a’ attributes may be encoded as described herein with respect to FIG. 13. The set ‘a’ of attributes (e.g., encoded set ‘a’ of attributes) may be decoded. The decoding may use prediction between one or more (e.g., three) levels of details, from a lowest (e.g., third) level of details to a highest (e.g., first) level of details (in reverse order of the encoder described herein with respect to FIG. 13).

At step 1410, the decoder may decode the first residual values ‘res a²’, the third residual values ‘res up a¹’, and/or further updated attribute values ‘up up a⁰’ of a fourth set of attributes (a⁰) from the bitstream. The decoder may use (e.g., apply) an optional dequantization for lossy compression. At step 1475, the decoder may determine update attribute values from the decoded third residual values ‘res up a¹’. Step 1475 may be performed in a manner similar to that described herein with respect to step 1385. The decoder may determine an update attribute value based on the third residual values. The update attribute value may be determined as the third residual values multiplied by a scaling factor (e.g., ½, ¼, ⅛) that may be predetermined or signaled in the bitstream.

At step 1480, the decoder may determine updated attribute values ‘up a⁰’ of the fourth set of attributes (a⁰), for example, by subtracting the update attribute values from the decoded further updated attribute values ‘up up a⁰’ of the fourth set of attributes (a⁰). At step 1420, the decoder may determine predictive values of the updated attribute values ‘up a¹’ of a third set of attributes (a¹) from the updated attribute values ‘up a⁰’ of the fourth set of attributes (a⁰). Step 1420 may be performed in a similar manner as described herein with respect to step 1350. At step 1430, the decoder may determine updated attribute values ‘up a¹’ of the third set of attributes (a¹), for example, by adding the predictive values to the decoded third residual values ‘res up a¹’. At step 1440, the decoder may determine a second set of attributes (a⁰ and a¹), for example, by merging the third set of attributes (a¹) and the fourth set of attributes (a⁰). Step 1440 may be an inverse of step 1340. The second set of attributes (a⁰ and a¹) may comprise updated attribute values ‘up a⁰’ and updated attribute values ‘up a¹’. At step 1485, the decoder may determine update attribute values from the decoded first residual values ‘res a²’. Step 1485 may be performed in a manner similar to that as described herein with respect to step 1375. The operations at steps 1420, 1430, 1440, 1475, and 1480 may be iteratively used for (e.g., applied to) each successively higher (e.g., finer) LoD.

At step 1490, the decoder may determine attribute values ‘a⁰’ and attribute values ‘a¹’ of the second set of attributes (a⁰ and a¹), for example, by subtracting the update attribute values from the updated attribute values ‘up a⁰’ and from updated attribute values ‘up a¹’ of the second set of attributes (a⁰ and a¹). At step 1450, the decoder may determine predictive values of the attributes of a first set of attributes (a²) from the attributes of the second set of attributes (a⁰ and a¹). Step 1450 may be performed in a manner similar to that described herein with respect to step 1320. At step 1460, the decoder may determine decoded attributes of the first set of attributes (a²), for example, by adding the predictive values to the decoded second residual values ‘res a²’. At step 1470, the decoder may determine the set ‘a’ of decoded attributes for the coded geometry S (e.g., the whole coded geometry), for example, by merging the first set of attributes (a²) and the second set of attributes (a⁰ and a¹). Step 1470 may be an inverse of step 1310.

Pred-lift schemes may be similar to the lifting scheme used for (e.g., applied to) wavelets in image coding. A pre-lift scheme may comprise update steps that are not in prediction transform scheme (e.g., in addition to the prediction steps in the prediction transform scheme). The update steps may provide better compression performance (e.g., in combination with the prediction steps). This may compact the energy in the lowest level of details, which may reduce distortion with lossy coding.

Attributes may be coded using the RAHT scheme. The RAHT scheme may be based on the iterative use of a two-point transform. In point cloud attribute coding, the two-point RAHT transform may be used for (e.g., applied to) two sets (A₁ and A₂) of attributes. Each of A₁ and A₂ may have respectively w₁ and w₂ number of attributes. Each of A₁ and A₂ may have respective associated coefficients c_{A1} and c_{A2}. Each of c_{A1} and c_{A2} is representative of the sum of attribute values over the corresponding set divided by the square root of the number of attributes.

$$\begin{matrix}{c}_{Ai} = \frac{1}{\sqrt{{w}_{i}}} {\sum }_{a ∈ {A}_{i}} a . & ( {w}_{i} = {A}_{i} )\end{matrix} \qquad ( ⋆ )$$

The two-point RAHT transform may depend on the weights w₁ and w₂. The two-point RAHT transform may be defined by a 2×2 matrix as follows

$$RaHT ( {w}_{1} , {w}_{2} ) = \frac{1}{\sqrt{{w}_{1} + {w}_{2}}} [ \begin{matrix}\sqrt{{w}_{1}} & \sqrt{{w}_{2}} \\ - \sqrt{{w}_{2}} & \sqrt{{w}_{1}}\end{matrix} ] .$$

Two new coefficients DC and AC may be determined, for example, if used for (e.g., applied to) the two coefficients c_{A1} and c_{A2}.

$$[ \begin{matrix}DC \\ AC\end{matrix} ] = RAHT ( {w}_{1} , {w}_{2} ) [ \begin{matrix}{C}_{A 1} \\ {C}_{A 2}\end{matrix} ]$$

As described herein, the above property (*) on coefficients may hold for the DC coefficient.

$$DC = \frac{1}{\sqrt{{w}_{1} + {w}_{2}}} ( \sqrt{{w}_{1}} {c}_{A 1} + \sqrt{{w}_{2}} {c}_{A 2} ) = \frac{1}{\sqrt{{w}_{1} + {w}_{2}}} ( {\sum }_{a ∈ {A}_{1}} a + {\sum }_{a ∈ {A}_{2}} a ) = \frac{1}{{w}_{1} + {w}_{2}} {\sum }_{a ∈ {A}_{1} ∪ {A}_{2}} a = {c}_{A 1 ∪ A 2}$$

The two point RAHT transform may be iteratively used for (e.g., applied to) DC coefficients. This may be referred to as the RAHT iterative method. AC coefficients may not undergo further transformation, for example, after being determined. At the start of the RAHT iterative method, there may be as many initial sets Aᵢ of attributes as there are points in the coded geometry S. Each initial set Aᵢ of attributes may contain one attribute (wᵢ=1). The coefficient c_{Ai} may be equal to the value of the one attribute, and/or may fulfill the property (*). By induction, the property (*) may hold for subsequent DC coefficients (e.g., all subsequent DC coefficients) determined, for example, after iterative application of the two point RAHT transform.

At a particular stage of the RAHT iterative method, determined coefficients may be the union of a set of DC coefficients fulfilling the property (*) and a set of AC coefficients. The RAHT iterative method may continue until DC coefficients are depleted and only one DC coefficient may be left. The one DC coefficient may be equal to C_{A} where A may be the set of attributes (e.g., all attributes) associated with the coded geometry S (e.g., the complete coded geometry S). The RAHT iterative method may follow an order among pairs of DC coefficients.

The two-point inverse RAHT transform may be defined by a 2×2 matrix as follows

$$iRAHT ( {w}_{i} , {w}_{2} ) = \frac{1}{\sqrt{{w}_{1} + {w}_{2}}} [ \begin{matrix}\sqrt{{w}_{1}} & - \sqrt{{w}_{2}} \\ \sqrt{{w}_{2}} & \sqrt{{w}_{1}}\end{matrix} ]$$

The two-point inverse RAHT transform may be used with respect to (e.g., applied to) DC and AC coefficients for obtaining back the two coefficients c_{A1} and c_{A2}.

$$[ \begin{matrix}{c}_{A 1} \\ {c}_{A 2}\end{matrix} ] = iRAHT ( {w}_{1} , {w}_{2} ) [ \begin{matrix}DC \\ AC\end{matrix} ]$$

The inverse iterative RAHT method may use (e.g., apply) the inverse two-point RAHT to DC and AC coefficient in reverse order relative to their obtention by the iterative RAHT method. At the end of the inverse iterative RAHT method, coefficients c_{Ai} associated with the initial sets Aᵢ of attributes may be obtained. These coefficients c_{Ai} may be equal to the values of the one attribute associated with the initial sets Aᵢ.

For lossy RAHT compression of attributes, coefficients may be further compressed based on using (e.g., applying) a quantization to the DC and AC coefficients, for example, before encoding in the bitstream. The decoder may use (e.g., apply) a dequantization, for example, after decoding of the quantized DC and AC coefficients from the bitstream.

The RAHT iterative method may follow an octree as a specific iterative order, for example, in G-PCC. One or more (e.g., up to eight) DC coefficients, associated with one or more (e.g., up to eight) occupied child nodes of a parent node in the octree, may undergo a cascade of two-point RAHT transformations until one DC coefficient remains, together with the remaining (e.g., up to seven) AC coefficients. This one DC coefficient may be pushed at parent node level. The method may be repeated at upper octree depth, for example, until the root node is reached.

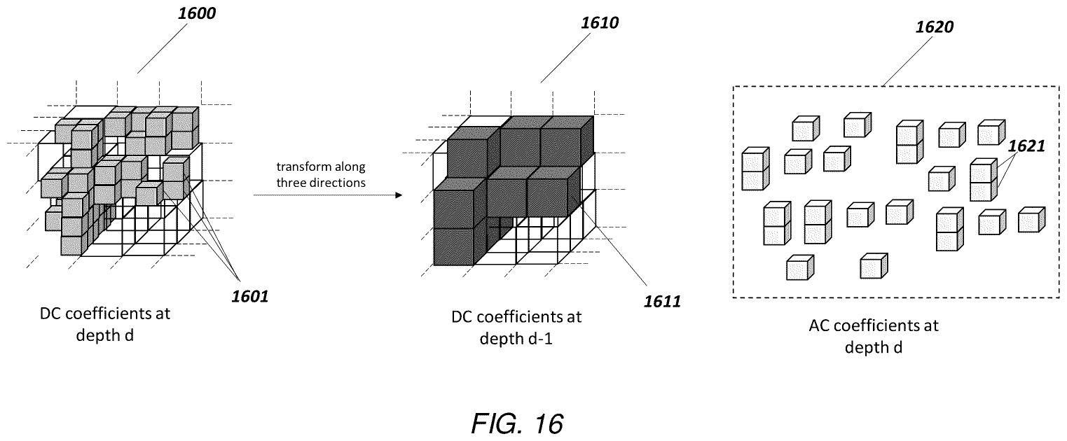

FIG. 15 shows an example RAHT transformation. The RAHT transformation may be applied on child nodes of an octree parent node along three successive directions. The parent node 1500 may have multiple (e.g., five) occupied child nodes each having a respective associated coefficient cᵢ and weight wᵢ. A first RAHT transformation 1510 may be performed along a first direction 1511. If there are two adjacent occupied child nodes 1513 along the first direction, the two adjacent occupied child nodes 1513 may undergo a two-point RAHT transform. A new DC coefficient 1514 and an AC coefficient 1515 may be determined and pushed to a set 1550 of AC coefficients. The node may be left as is and its DC coefficient may be kept 1517, for example, if there is only one occupied child node 1516 along the first direction. In this example, the child nodes may be collapsed along the first direction to determine a new set 1519 of nodes (e.g., a set of three nodes), with associated new DC coefficients, may be determined.

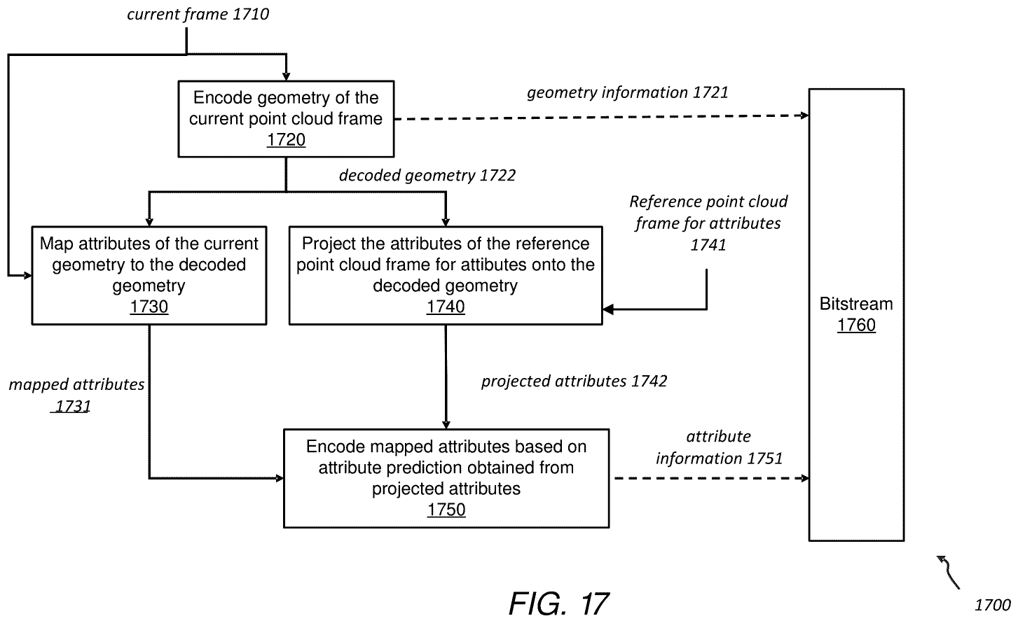

A second RAHT transformation 1520 may be performed, for example, after the first RAHT transformation. The second RAHT transformation may be along a second direction 1521. The second RAHT transformation may be performed similarly to the first RAHT transformation. The child nodes 1522 may be determined. The child nodes 1522 may have been collapsed along the first two directions 1511 and 1521. The AC coefficients 1523 may be pushed to the set 1550 of AC coefficients. A third RAHT transformation 1530 may be performed, for example, after the second RAHT transformation. The third RAHT transformation may be along a third direction 1531. The third RAHT transformation may be performed similarly to the first and/or second RAHT transformation. A (e.g., unique) child node 1532 may be determined. The child node 1532 may result from the collapse along all three directions. The AC coefficients 1533 may be pushed to the set 1550 of AC coefficients. The child node 1532 may have an associated DC coefficient that is pushed to the parent node (e.g., as shown for example in FIG. 16).

FIG. 16 shows an example RAHT transformation. The RAHT transformation may be used for (e.g., applied to) octree nodes (e.g., all octree nodes) at depth ‘d’ to determine DC coefficients at depth d−1 and AC coefficients. Occupied nodes 1600 of an octree may be at depth d. Occupied nodes 1600 may undergo a RAHT transformation along the three directions. DC coefficients for each node may be pushed up to the corresponding occupied parent nodes 1610 that belong to the octree at depth d−1. The three DC coefficients of the child nodes 1601 may, for example, undergo a RAHT transformation along the three directions. A unique DC coefficient associated with the parent node 1611 may be determined and two AC coefficients 1621 may be pushed to a set 1620 of AC coefficients. By performing this method for (e.g., all) occupied nodes 1600 of the octree at depth d, the DC coefficients associated with occupied nodes of the octree at depth d may be transformed into DC coefficients associated with occupied nodes 1610 of the octree at depth d−1 and a set 1620 of AC coefficients.

This bottom-up method may be repeated depth per depth, for example, until reaching the minimum depth (the root node). The result of the RAHT transformation over the octree (e.g., complete octree) may be a set of coefficients comprising a unique DC coefficient and a set of (many) AC coefficients. The RAHT transformation method may start from the highest depth where occupied child nodes correspond to a unique point (voxel) of the coded point cloud S. The unique point may be associated with a unique attribute among the set ‘a’ of attributes. The DC coefficient at highest depth may be set as the value of the unique attribute associated with each occupied node. The weights ‘w’ may be set to 1.

The inverse RAHT method on an octree may be a top-down method, from the root node down to the last depth made of leaf nodes that each contain one point of the point cloud, and one associated attribute. The DC coefficients of occupied nodes 1610 of the octree at depth d−1 may be inverse transformed into DC coefficients of occupied nodes 1600 of the octree at depth d, for example, by using (e.g., applying) the inverse two-point RAHT transform to the DC coefficient of each of the occupied node of the octree at depth d−1 and to the related AC coefficients from set 1620 of AC coefficients. The inverse two-point RAHT transform may be applied along the three directions, in reverse order to invert the node transformation as described herein with respect to FIG. 15. DC coefficients of the leaf nodes may be obtained, and the values of the DC coefficients may correspond to the attributes associated with the unique point of each of the leaf nodes. Like geometry coding of a point cloud, coding of attributes associated with the points of a current point cloud may benefit from inter frame prediction using a motion compensated point cloud. The motion compensated point cloud may inherit attributes from a reference point cloud that has been motion compensated. If, for example, motion occurs, points may keep their associated attributes. The motion compensated attributes (e.g., the attributes associated with the points of the motion compensated point cloud) may be used. This may improve compression of the attributes of the coded geometry of the current point cloud.

Inter pred-lift scheme may use motion compensated attributes or residual attributes based on differences between attributes and motion-compensated attributes. Using residual attributes may increase compression. Inter pred-lift scheme may be used in the pred-lift scheme, for example, by plugging the inter pred-lift scheme to the prediction steps 1120, 1150, 1220, 1250, 1320, 1350, 1420 and/or 1450. Attributes (or residual attributes) aⁱ of the set Sⁱ of points may be predicted, for example, by attributes (or residual attributes) of the subsets a⁰, . . . , aⁱ⁻¹ of the lower level of details S⁰∪ . . . ∪Sⁱ⁻¹. Additionally or alternatively, attributes (or residual attributes) aⁱ of the set Sⁱ of points may be predicted by motion compensated attributes (or residual attributes) of a set a^{inter} associated with points of a motion compensated point cloud S^{inter}. The prediction step may be performed, for example, based on attributes (or residual attributes) of subsets a⁰, . . . , aⁱ⁻¹ and of a set a^{inter} of an augmented lower level of details S⁰∪ . . . ∪Sⁱ⁻¹∪S^{inter}.

The encoder and/or decoder may determine predictive values of the attributes (or residual attributes) of the fourth set of attributes (or residual attributes) (subset a⁰ of the coarsest level of details S⁰) from the motion compensated attributes (or residual attributes) of the set a^{inter} associated with the points of a motion compensated point cloud S^{inter}. The encoder and/or decoder may subtract the predictive values from the attributes (or residual attributes) of the fourth set of attributes (or residual attributes) to determine residual values ‘res a⁰’. The encoder may encode the residual values ‘res a⁰’ (or residual of residual attributes) into the bitstream instead of the attributes (or residual attributes) of the fourth set of attributes.

Inter RAHT scheme may use inter prediction for predicting the values of the DC and the AC coefficients determined by the RAHT iterative method. It may be beneficial to maintain a common attribute octree structure for both a current point cloud S^{coded} to be coded and a motion compensated point cloud S^{inter}, for example, because the generation of DC and AC coefficients follows an octree. A common bounding box encompassing both point clouds may be determined. An octree partitioning may be performed, from a root node associated with the common bounding box, for both point clouds. This may lead to two octree partitioning that may be differently, for example, if the point clouds are not equal. The two octrees may have a common subtree starting from the root node. On the common subtree, occupied node topology may be the same, and/or a common set of DC and AC coefficients may be determined for both point clouds. The subset of DC and AC coefficients, associated with nodes of the common subtree and determined from the attributes of the current point cloud S^{coded}, may be predicted from DC and AC coefficients determined from the attributes of the motion compensated point cloud S^{inter}. The encoder and/or decoder may determine coefficient residual values, for example, by subtracting the DC and AC coefficients, determined from the attributes of the motion compensated point cloud S^{inter}, from the DC and AC coefficients associated with nodes of the common subtree and determined from the attributes of the current point cloud S^{coded}. The encoder may encode, into the bitstream, the coefficient residual values and/or may not encode, into the bitstream, the DC and AC coefficients associated with nodes of the common subtree and determined from the attributes of the current point cloud S^{coded}.

The DC and AC coefficients that are not associated with nodes of the common subtree may not be predicted, and/or may be coded directly in a similar way as performed without inter prediction. Additionally or alternatively, predicted DC coefficients of the current point cloud S^{coded} may be determined at some depth (e.g., without predicting AC coefficients at the same depth). This may be based on the assumption that both the octree of the current point cloud S^{coded} and the octree of the motion compensated point cloud S^{inter} have a same occupancy of a node at this depth. The predicted DC coefficients may be determined from the corresponding co-located DC coefficients of the motion compensated point cloud S^{inter}. DC residual values may be determined, for example, by subtracting the predicted DC coefficients from the DC coefficients of the current point cloud S^{coded}. The RAHT transformation may go up in the octree starting from DC residual values replacing the DC coefficients of the coded current point cloud, for example, after the predicted DC coefficients be determined.

A RAHT scheme that does not use information from a reference frame different from the current frame may be called an intra RAHT scheme. Intra prediction may be performed between DC and AC coefficients of an intra RAHT scheme. Inter-depth prediction within a current frame may have been integrated into, for example, the RAHT scheme of GPCC. The inter-depth prediction mechanism may predict the DC coefficients associated with nodes of the octree at depth d, for example, by using interpolation of DC coefficients associated with nodes of the octree at lower depth d−1.

For compressing colored dynamic dense point cloud (e.g., in the context of AR/VR), attribute related data may constitute a large portion of the bitstream. Compressing the attribute related data efficiently may improve storage and/or transmission of such point clouds. Geometry may be lossy compressed (e.g., using a TriSoup scheme), and/or colors may be lossy compressed (e.g., using the RAHT transform or the pred-lift scheme). For point cloud compression, the RAHT transform may be selected, for example, based on the RAHT transform having better performance than the pred-lift scheme.

In at least some systems, inter RAHT may have achieved compression gains, for example, compared with intra RAHT. Inter RAHT may be based on prediction of coefficients from a motion compensated colored point cloud. The gains from inter RAHT may drop (e.g., significantly) in regions where the motion is complex. The drop may occur, for example, if the (motion) compensation is unable (e.g., unlikely) to provide a large enough common part to two octrees that are partitioned for the current point cloud S^{coded} and the motion compensated point cloud S^{inter}. The number of DC and AC coefficients that may be inter predicted may be limited and the use of inter RAHT may not be efficient. In at least some systems, inter RAHT may be sensitive to geometry differences between the current point cloud S^{coded} and the motion compensated point cloud S^{inter} And attribute correlation between these two point clouds may be difficult to utilize.

As described herein, a projection-based compression may be used. The projection-based compression may be used for compressing attributes of point clouds. An encoder may determine attributes of a reconstructed geometry of a point cloud frame. This determination may be based on attributes of a geometry of the point cloud frame. The encoder may map attributes of the geometry of the point cloud frame to the reconstructed geometry, for example, in lossy compression. The attributes of the reconstructed geometry may be determined based on the mapping. The attributes of the geometry may be the same as the attributes of the reconstructed geometry, for example, in lossless compression. The encoder may determine attribute predictors of the attributes of the reconstructed geometry. The attribute predictors may be determined, for example, based on projecting attributes of a reference point cloud frame for attributes onto the reconstructed geometry. The attributes of the reconstructed geometry may be encoded based on the attribute predictors. The attributes may be encoded as attribute residuals. Attribute residuals indicating differences between the attributes of the reconstructed geometry and the attribute predictors may be encoded into a bitstream associated with the point cloud frame. The attribute residuals may be used, for example, by a decoder, to determine the attributes of the reconstructed geometry of the point cloud frame.

A decoder may perform inverse operations to reconstruct (e.g., decode) the attributes of the point cloud frame. The decoder may determine a reconstructed geometry of the point cloud frame, for example, by decoding geometry information of a point cloud frame. The reconstructed geometry, determined by the decoder, may be the same as the reconstructed geometry determined by the encoder. Attribute predictors of attributes of the reconstructed geometry may be determined, for example, by the decoder. The decoder may determine the attribute predictors similarly as performed by the encoder. The decoder may determine the attribute predictors, for example, based on projecting attributes of a reference point cloud frame, for attributes, onto the reconstructed geometry. The attribute predictors may be reciprocally (e.g., independently and/or identically) determined by the encoder and the decoder. The attribute predictors may not be indicated in (e.g., encoded into or signaled in) the bitstream. The decoder may decode the attributes of the reconstructed geometry, for example, based on the attribute predictors. The decoder may receive/determine (e.g., decoded) attribute residuals from a bitstream. The attributes may be determined, for example, based on adding the attribute predictors to the attribute residuals.

The reference point cloud frame for attributes may be an already-coded reference frame. The already-coded reference frame may be a reference frame used to encode geometry information of the point cloud frame. Additionally or alternatively, the already-coded reference frame may be a different reference frame than the one used to encode the geometry of the point cloud frame. The reference point cloud frame for attributes may be a motion-compensated point cloud frame. The motion-compensated point cloud frame may be determined (e.g., generated), for example, based on the already-coded reference frame (e.g., as described herein with respect to FIG. 10). The attribute residuals may be further compressed (e.g., encoded and/or decoded) using an intra transform scheme (e.g., a pred-lift transform or a (intra) RAHT scheme). Projected attributes and coded attributes may belong to the same geometry of the point cloud frame. The prediction of the coded attributes based on the projected attributes may be more efficient than predicting (e.g., directly) from a motion compensated point cloud frame, for example, because the geometry discrepancy, between the reconstructed geometry and a motion compensated point cloud geometry, may have been reduced or removed.

As described herein, the decoded geometry of a point cloud frame may correspond to a reconstructed geometry of the point cloud frame. An encoder may determine the reconstructed geometry, for example, based on encoding a geometry of the point cloud frame and decoding the encoded geometry. The reconstructed geometry at the encoder may be the same as the geometry decoded at the decoder. The decoder may reconstruct the same reconstructed geometry as that at the encoder.

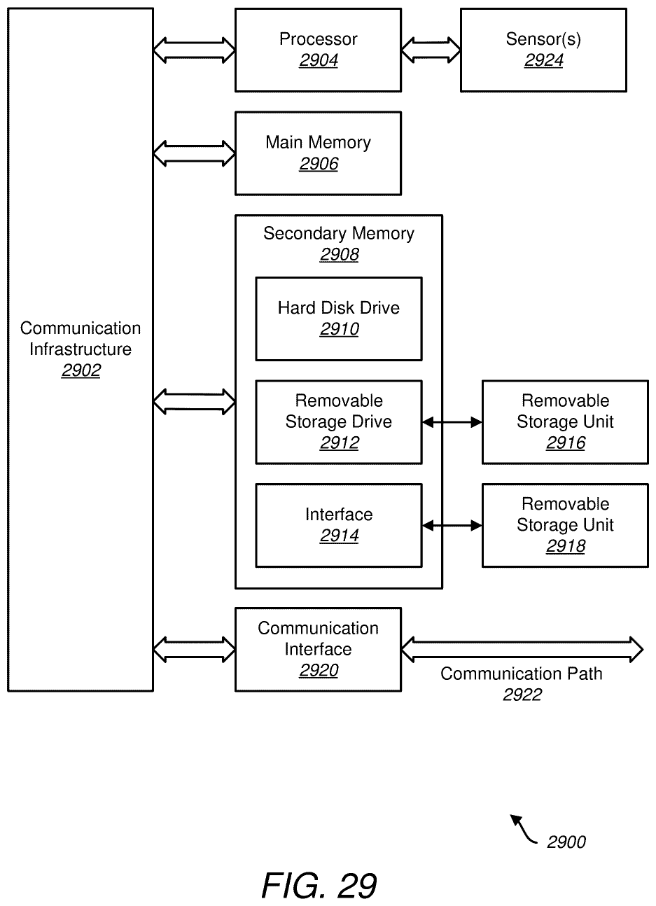

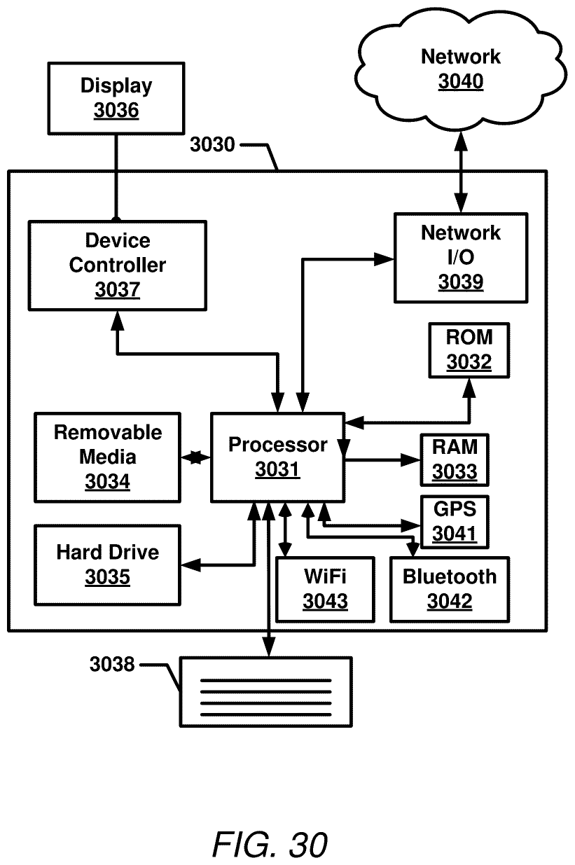

FIG. 17 shows an example method for encoding point cloud frames. Geometry and/or attributes of a current point cloud frame (e.g., current point cloud frame 1710) may be encoded. The current point cloud frame 1710 may be a frame of a sequence of point cloud frames (e.g., a dynamic point cloud). One or more steps of the example method of FIG. 17 (e.g., method 1700) may be performed and/or implemented by an encoder (e.g., encoder 114 of FIG. 1), an example computer system 2900 in FIG. 29, and/or an example computing device 3030 in FIG. 30. In some examples, steps 1720, 1730, 1740, and 1750 may represent components within the encoder. Steps (e.g., blocks) of the example method of FIG. 17 may be omitted, performed in other orders, and/or otherwise modified and/or one or more additional steps may be added.

At step 1720, an encoder (e.g., a geometry encoder) may encode geometry information 1721 of the current point cloud frame 1710. The encoded geometry information 1721 may be sent into a bitstream 1760. The encoder may determine a decoded geometry 1722 (e.g., reconstructed geometry) of the current point cloud frame. The encoder may determine the decoded geometry 1722, for example, based on decoding the encoded geometry information 1721. The decoded geometry 1722 and the geometry (e.g., original geometry) of the current point cloud frame 1710 may differ. The decoded geometry 1722 and the geometry (e.g., original geometry) may differ significantly, for example, if the geometry compression is lossy.

At step 1730, the encoder (e.g., an attributes determiner) may determine mapped attributes 1731 associated with the decoded geometry 1722 of the current point cloud frame. The encoder may determine the mapped attributes 1731, for example, by mapping the attributes associated with the geometry (e.g., original) of the current point cloud frame 1710 to the decoded geometry 1722 of the current point cloud frame.

Attributes may comprise colors. The mapped attributes may be determined, for example, based on recoloring the attributes. Mapped attributes may be determined, for example, based on a k nearest neighbor (KNN) search algorithm to determine nearest points from the geometry of the current point cloud frame 1710 to the decoded geometry 1722. The k nearest neighbor (KNN) search algorithm may include, for example, using a space partitioning algorithm such as a KD Tree search, a Ball/metric Tree search, a Brute force search, etc.). A mapped attribute of a point of the decoded geometry 1722 may be, for example, the average attribute values associated with the nearest points of the current point cloud frame 1710 relative to the point of the decoded geometry. The decoded geometry 1722 (e.g., reconstructed geometry) of the geometry of the current point cloud frame may be the same as the geometry (e.g., original geometry) of the current point cloud frame 1710, for example, if the geometry compression is lossless. The attribute mapping may associate attributes of each point of the geometry of the current point cloud frame to the same point of the decoded geometry 1722.

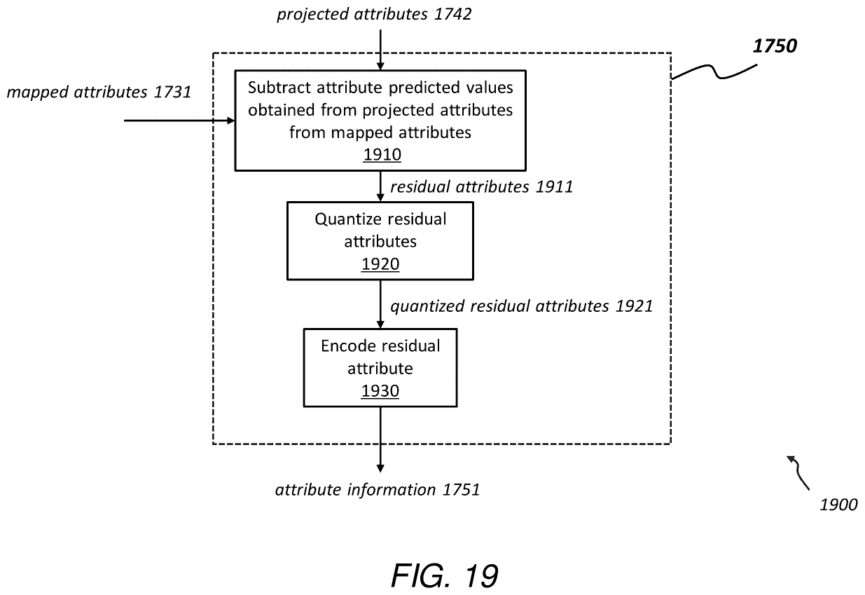

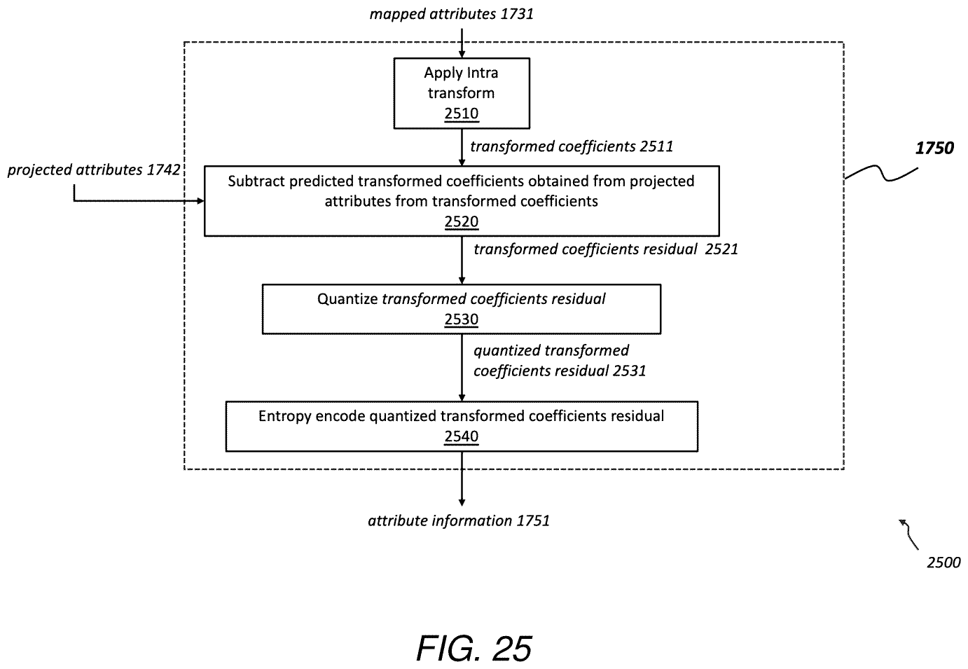

At step 1740, the encoder (e.g., an attributes projector) may determine projected attributes 1742, for example, by projecting the attributes of a reference point cloud frame for attributes 1741 onto the decoded geometry 1722. At step 1750, the encoder (e.g., an attributes encoder) may encode (e.g., generate) attribute information 1751 and send/signal the attribute information 1751 to/into the bitstream 1760. The attribute information 1751 may represent the mapped attributes 1731 associated with the decoded geometry 1722. The attribute information 1751 may be based on attribute prediction determined from the projected attributes 1742. Attribute prediction may comprise attribute predictors determined from the projected attributes 1742 as described herein, for example, with respect to FIG. 19 and FIG. 25.

The reference point cloud frame for attributes may be an already-coded reference point cloud frame. The already-coded reference point cloud frame may have been previously selected to encode geometry of the current point cloud frame (e.g., at step 1720). The already-coded reference point cloud frame for determining the project attributes 1742 may be different from the already-coded reference point cloud frame used at step 1720. The already-coded reference point cloud frame may be motion compensated, for example, by using a motion vector MV field. The already-coded reference point cloud frame and/or the motion vector MV field may be encoded in bitstream 1760.

The reference point cloud frame for attributes 1741 may be determined from the already-coded reference point cloud frame. The already-coded reference point cloud frame may be motion compensated by a motion vector MV field that may be encoded in bitstream 1760. The attributes of the already-coded reference point cloud frame may be moved together with the points such that the reference point cloud frame for attributes 1741 possesses attributes, for example, if motion compensation occurs.

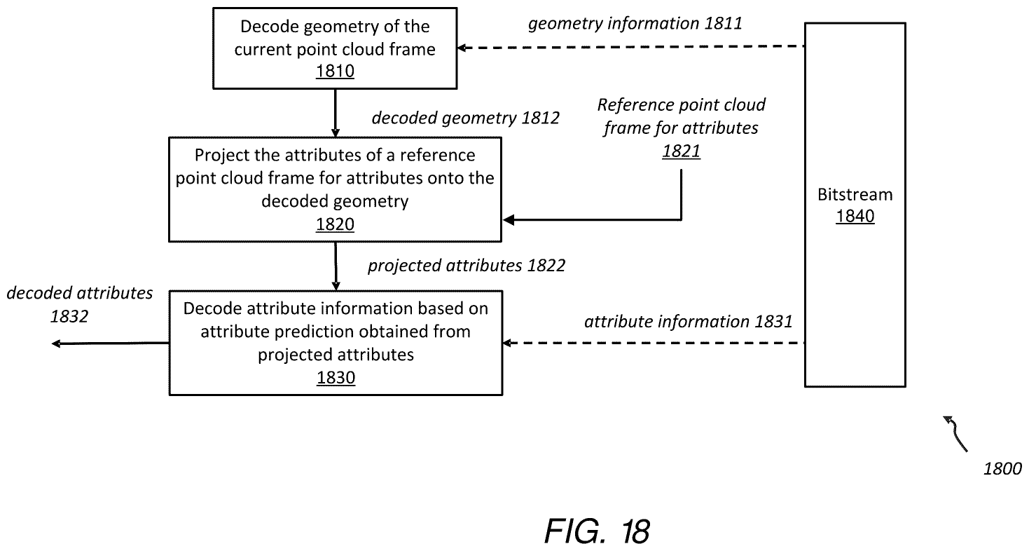

FIG. 18 shows an example method for decoding point cloud frames. Geometry and/or attributes of a current point cloud frame may be decoded. The current point cloud frame may be a frame of a sequence of point cloud frames (e.g., a dynamic point cloud). The current point cloud frame may be encoded as described herein with respect to FIG. 17. One or more steps of the example method of FIG. 18 (e.g., method 1800) may be performed and/or implemented by a decoder (e.g., decoder 120 of FIG. 1), an example computer system 2900 in FIG. 29, and/or an example computing device 3030 in FIG. 30. In some examples, steps 1810, 1820, and 1830 may represent components within the decoder. Steps (e.g., blocks) of the example method of FIG. 18 may be omitted, performed in other orders, and/or otherwise modified and/or one or more additional steps may be added.

At step 1810, the decoder (e.g., a geometry decoder) may provide (e.g., determine) decoded geometry 1812 (e.g., the reconstructed geometry at the encoder) of the current point cloud frame. The decoded geometry 1812 may be provided/determined by decoding geometry information 1811 from a bitstream 1840. The decoded geometry 1812 may be the decoded geometry 1722 as described herein with respect to FIG. 17.

At step 1820, the decoder (e.g., an attributes projector) may determine projected attributes 1822. The projected attributes may be determined, for example, by projecting the attributes of a reference point cloud frame for attributes 1821 onto the decoded geometry 1812. Projected attributes 1822 may be the same as the projected attributes 1742 as described herein with respect to FIG. 17. Similarly, the reference point cloud frame for attributes 1821 may be the same as the reference point cloud frame for attributes 1741 as described herein with respect to FIG. 17.

At step 1830, the decoder (e.g., an attributes decoder) may determine decoded attributes 1832 associated with the decoded geometry 1812. The decoded attributes 1832 may be determined, for example, by decoding attribute information 1831 from bitstream 1840 based on attribute prediction. The attribute prediction and/or the decoded attributes 1832 may be determined from the projected attributes 1822.

The reference point cloud frame for attributes 1821 may be an already-coded reference point cloud frame. The already-coded reference point cloud frame may have been previously determined to decode geometry of the current point cloud frame at step 1810. A motion vector, indicating the already-coded reference point cloud frame, may be decoded from geometry information 1811. The already-coded reference point cloud frame for determining the project attributes 1822 may be either the same or different from the already-coded reference point cloud frame used at step 1810. The already-coded reference point cloud frame may be motion compensated, for example, by using a motion vector MV field. The already-coded reference point cloud frame and/or the motion vector MV field may be decoded from bitstream 1840.

The reference point cloud frame for attributes 1821 may be a motion compensated point cloud frame determined from the already-coded reference point cloud frame. The motion compensated point cloud frame may be motion compensated by a motion vector (MV) field. The MV field may be decoded from the bitstream 1840. The attributes of the already-coded reference point cloud frame may be moved together with the points such that the reference point cloud frame for attributes 1821 may possess attributes, for example, if motion compensation occurs. The reference point cloud frame for attributes 1821 may be the same as (or different from) the reference point cloud frame for attributes 1741 as described herein with respect to FIG. 17.

Projected attributes 1742, projected attributes 1822, mapped attributes 1731, and/or decoded attributes 1832, may belong to the same decoded geometry 1722 (and/or decoded geometry 1812). Attribute predictors for mapped attributes 1731 (e.g., corresponding to the current frame 1710) may be determined from the projected attributes 1742 and/or projected attributes 1822. Attribute predictors for mapped attributes 1731 (e.g., corresponding to the current frame 1710) may be determined from the projected attributes 1742 and/or projected attributes 1822 in a similar manner as described herein with respect to steps 1750 and 1830. Determining attribute prediction (e.g., attribute predictors) from projected attributes may be performed reciprocally (e.g., independently and/or identically) at the encoder and decoder. This may result in reducing the size of the compressed attribute information 1751 in bitstream 1760, (and/or reducing the size of the compressed attribute information 1831 in bitstream 1840).

Attribute predictors (e.g., residual attribute predictors if an intra transform is used for (e.g., applied to) residual attributes) may be determined based on a pred-lift scheme (e.g., as described herein with respect to FIG. 11 and/or FIG. 13). The attribute predictors may be determined, for example, based on predicting attributes aⁱ of the set Sⁱ of points from attributes a⁰, . . . , aⁱ⁻¹ of the lower level of details S⁰∪ . . . ∪Sⁱ⁻¹ and/or from the projected attributes 1742. It is appreciated that the inputs aⁱ may represent residual attributes. The inputs aⁱ may or may not represent attribute values.

Attribute predictors may be determined based on the pred-lift schemes (e.g., as described herein with respect to FIG. 12 and/or FIG. 14). Attributes aⁱ of the set Sⁱ of points may be predicted, for example, from attributes a⁰, . . . , aⁱ⁻¹ of the lower level of details S⁰∪ . . . ∪Sⁱ⁻¹ and/or from the projected attributes 1822. Attribute prediction may be determined, for example, from projected attributes 1742 (and/or projected attributes 1822). The attribute prediction may be based on (e.g., use) an inter RAHT scheme. The RATH scheme may use the same octree partitioning for mapped attributes 1731, decoded attributes 1832, projected attributes 1742, and/or projected attributes 1822. A same octree partitioning may be use, for example, if the mapped attributes and projected attributes are both associated with a same decoded geometry 1722 (and/or decoded geometry 1812).

Each DC and/or AC coefficient determined as output of the inter RAHT scheme applied on mapped attributes 1731 may be predicted by the co-located DC and/or AC coefficients obtained as output of the inter RAHT scheme applied on the projected attributes 1742. Each DC and/or AC coefficient determined as output of the inter RAHT scheme applied on decoded attributes 1832 may be predicted by the co-located DC and/or AC coefficients obtained as output of the inter RAHT scheme applied on the projected attributes 1822. The problem of the sensitivity of the inter RAHT schema to geometry differences between the current point cloud and the motion compensated point cloud may be solved, for example, if the mapped, projected, and/or decoded attributes are associated with a same decoded geometry 1722 (and/or a same decoded geometry 1812).

FIG. 19 shows an example method for encoding mapped attributes of a point cloud frame. The mapped attributes may be encoded, for example, based on attributes prediction (e.g., attribute predictors) determined from projected attributes. One or more steps of the example method of FIG. 19 (e.g., method 1900) may be performed and/or implemented by an encoder (e.g., the encoder 114 in FIG. 1), an example computer system 2900 in FIG. 29, and/or an example computing device 3030 in FIG. 30. Steps (e.g., blocks) of the example method of FIG. 19 may be omitted, performed in other orders, and/or otherwise modified and/or one or more additional steps may be added.

The method 1900 may correspond to step 1750 of FIG. 17. At step 1910, the encoder may determine predicted attributes (e.g., also referred to as attribute predictors) from (e.g., based on) the projected attributes 1742. The encoder may determine residual attributes 1911, for example, by subtracting the predicted attributes from the mapped attribute 1731. At step 1920, the encoder may determine quantized residual attributes 1921, for example, by quantizing the residual attributes 1911. The encoder may determine quantized residual attributes 1921, for example, for lossy compression. Quantizing may be used, for example, if lossy compression is allowed. At step 1930, the encoder may encode the residual attributes 1911 as attribute information 1751 into bitstream 1760. Additionally or alternatively, the encoder may encode the quantized residual attributes 1921 as attribute information 1751 into bitstream 1760.

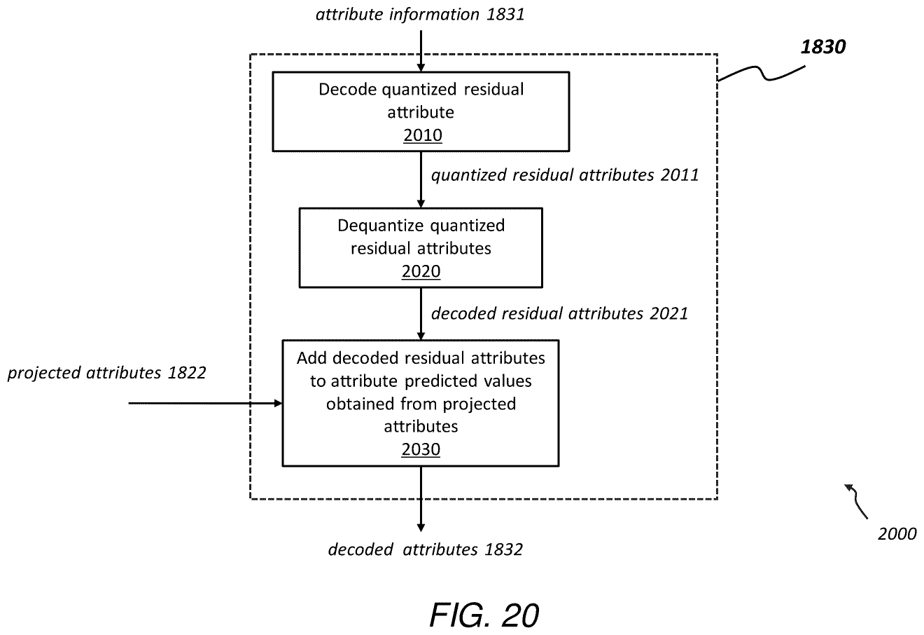

FIG. 20 shows an example method for decoding attribute information of a point cloud frame. The attribute information may be decoded, for example, based on attributes prediction (e.g., attribute predictors). The attribute prediction may be determined from projected attributes. One or more steps of the example method of FIG. 20 (e.g., method 2000) may be performed and/or implemented by a decoder (e.g., the decoder 120 in FIG. 1), an example computer system 2900 in FIG. 29, and/or an example computing device 3030 in FIG. 30. Steps (e.g., blocks) of the example method of FIG. 10 may be omitted, performed in other orders, and/or otherwise modified and/or one or more additional steps may be added.

The method 2000 may correspond to step 1830 of FIG. 18. At step 2010, the decoder may determine residual attributes (e.g., quantized residual attributes 2011), for example, by decoding attribute information 1831 from the bitstream 1840. At step 2020, the decoder may dequantize the residual attributes 2011, for example, if the residual attributes 2011 are quantized. The decoder may determine a decoded residual attribute, for example by dequantizing the quantized residual attributes 2011. At step 2030, the decoder may determine predicted attributes (e.g., also referred to as attribute predictors) from the projected attributes 1822. The decoder may determine decoded attributes 1832, for example, by adding the decoded residual attributes 2021 to the predicted attributes.

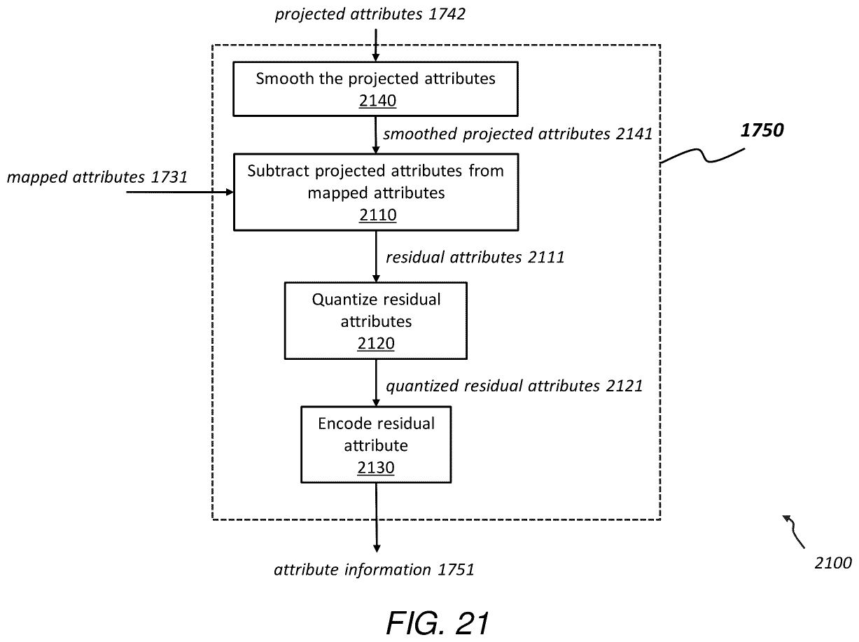

FIG. 21 shows an example method for encoding mapped attributes of a point cloud frame. The mapped attributes may be encoded, for example, based on attribute prediction (e.g., attribute predictors). The attribute prediction may be determined from projected attributes. One or more steps of the example method of FIG. 21 (e.g., method 2100) may be performed and/or implemented by an encoder (e.g., encoder 114 of FIG. 1), an example computer system 2900 in FIG. 29, and/or an example computing device 3030 in FIG. 30. Steps (e.g., blocks) of the example method of FIG. 21 may be omitted, performed in other orders, and/or otherwise modified and/or one or more additional steps may be added.

The method 2100 may correspond to step 1750 of FIG. 17. At step 2140, the encoder may determine smoothed projected attributes 2141, for example, by smoothing the projected attributes 1742. Smoothing the projected attributes 1742 may comprise removing spurious high frequencies that may be damaging to compression performance. The smoothed value of a projected attribute associated with a point of the decoded geometry may be obtained, for example, by averaging the values of projected attributes (e.g., before smoothing) associated with points of the decoded geometry belonging to a neighborhood of the point. This may be known as smoothing over a 3D kernel. The 3D kernel for smoothing may define and/or be used to determine the shape of the function that is used to take the average of the neighboring points. The 3D kernel may define and/or be used to determine the neighborhood as points of which voxels intersect the voxel of the point.

At step 2110, the encoder may determine predicted attributes from the smoothed projected attributes 2141. The encoder may determine residual attributes 2111 (e.g., residual values for attributes), for example, by subtracting the predicted attributes from the mapped attributes 1731. At step 2120, the encoder may determine quantized residual attributes 2121 by quantizing the residual attributes 2111. Quantizing may be used, for example, if lossy compression is allowed. At step 2130, the encoder may encode the residual attributes 2111 as attribute information 1751 into bitstream 1760. Additionally or alternatively, the encoder may encode the quantized residual attributes 2121 (e.g., quantized residual values) as attribute information 1751 into bitstream 1760.

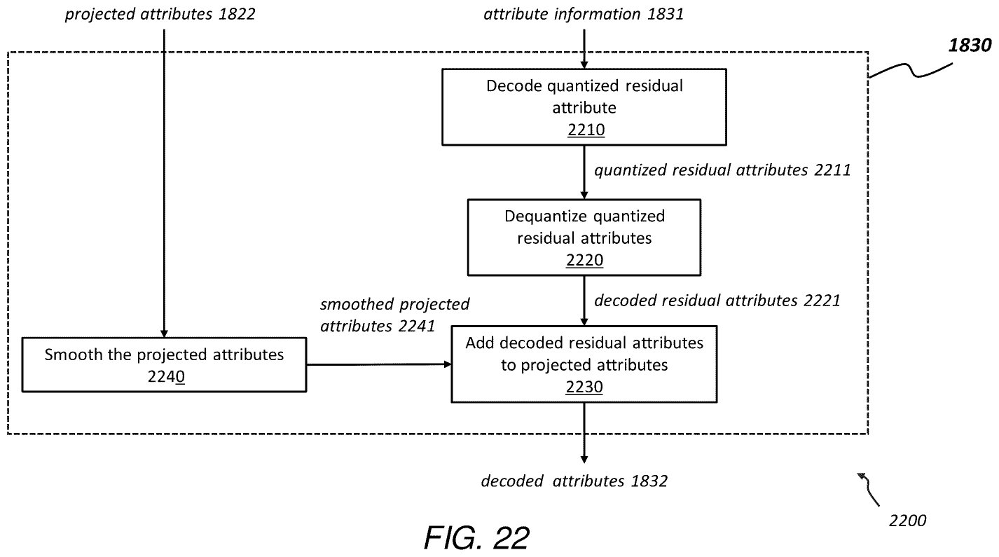

FIG. 22 shows an example method for decoding attribute information of a point cloud frame. The attribute information may be decoded, for example, based on attributes prediction (e.g., attribute predictors). The attribute prediction may be determined from projected attributes. One or more steps of the example method of FIG. 22 (e.g., method 2200) may be performed and/or implemented by a decoder (e.g., decoder 120 of FIG. 1), an example computer system 2900 in FIG. 29, and/or an example computing device 3030 in FIG. 30. Steps (e.g., blocks) of the example method of FIG. 22 may be omitted, performed in other orders, and/or otherwise modified and/or one or more additional steps may be added.

The method 2200 may correspond to step 1830 of FIG. 18. At step 2210, the decoder may determine residual attributes (e.g., quantized residual attributes 2211), for example, by decoding attribute information 1831 from the bitstream 1840. At step 2220, the decoder may dequantize the residual attributes 2211, for example, if the residual attributes at step 2210 is quantized. The decoder may determine a decoded residual attribute 2221 by dequantizing the quantized residual attributes 2211. At step 2240, the decoder may determine smoothed projected attributes 2241 (e.g., attribute values), for example, by smoothing the projected attributes 1822. Smoothing the projected attributes 1822 may comprise removing spurious high frequencies that may be damaging to compression performance.

At step 2230, the decoder may determine predicted attributes from the smoothed projected attributes 2241. The decoder may determine decoded attributes 1832, for example, by adding the decoded residual attributes 2221 to the predicted attributes. Residual attributes may be encoded (e.g., at steps 1930, 2130) and decoded (e.g., at steps 2010, 2210) by any intra attribute coding scheme, for example, because inter correlation may be determined by constructing residual attributes. The residual attributes may be encoded and/or decoded by a pred-lift scheme in which S may be a set of residual attributes (e.g., all residual attributes) to be coded.

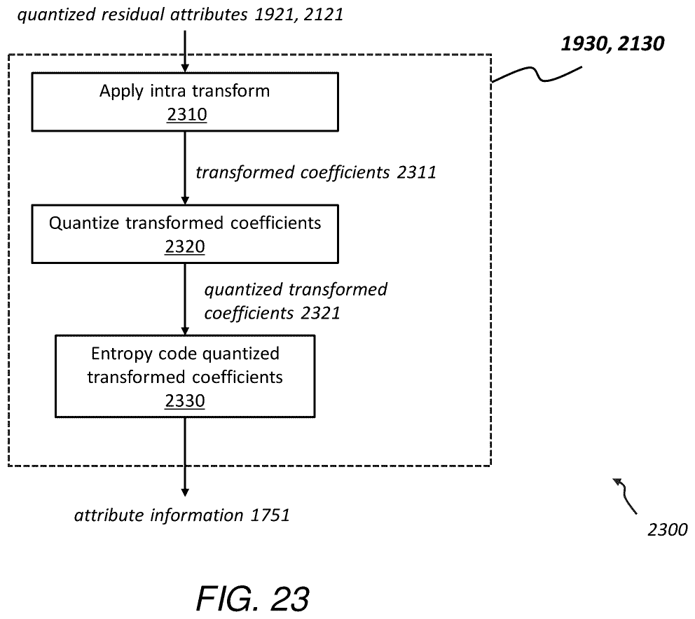

FIG. 23 shows an example method for encoding residual attributes. Step 2300 may correspond to step 1930 of FIG. 19, or step 2130 of FIG. 21. One or more steps of the example method of FIG. 23 (e.g., method 2300) may be performed and/or implemented by an encoder (e.g., encoder 114 of FIG. 1), an example computer system 2900 in FIG. 29, and/or an example computing device 3030 in FIG. 30. Steps (e.g., blocks) of the example method of FIG. 23 may be omitted, performed in other orders, and/or otherwise modified and/or one or more additional steps may be added.

At step 2310, the encoder may determine transformed coefficients 2311. The transformed coefficients 2311 may be determined, for example, by using (e.g., applying) an intra transform to the residual attributes. At step 2320, the encoder may determine quantized transformed coefficients 2321, for example, by quantizing the transformed coefficients 2321. Quantizing may be used, for example, if lossy compression is allowed. At step 2330, the encoder may encode (e.g., entropy encode) the transformed coefficients 2311 as attribute information 1751. Additionally or alternatively, the encoder may encode (e.g., entropy encode) the quantized transformed coefficients 2321 as attribute information 1751.

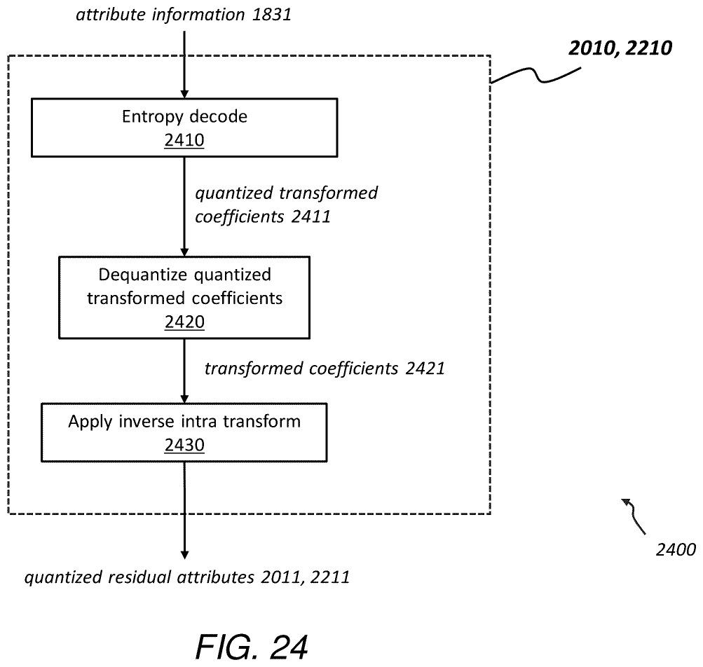

FIG. 24 shows an example method for decoding residual attributes. One or more steps of the example method of FIG. 17 (e.g., method 1700) may be performed and/or implemented by an encoder (e.g., encoder 114 of FIG. 1), an example computer system 2900 in FIG. 29, and/or an example computing device 3030 in FIG. 30. Steps (e.g., blocks) of the example method of FIG. 17 may be omitted, performed in other orders, and/or otherwise modified and/or one or more additional steps may be added.

The method 2400 may correspond to step 2010 of FIG. 20, or step 2210 of FIG. 22. At step 2410, the decoder may determine transformed coefficients (e.g., quantized transformed coefficients 2411), for example, by entropy decoding attribute information 1831. At step 2420, the decoder may dequantize the transformed coefficients 2411, for example, if the transformed coefficients 2411 at step 2410 are quantized. The decoder may determine transformed coefficients 2421 by dequantizing the quantized transformed coefficients 2411. At step 2430, the decoder may determine residual attributes by using (e.g., applying) an inverse intra transform to the residual attributes. The operations of the inverse intra transform may correspond to the inverse operations of the intra transform as described herein with respect to step 2310. The intra transform may be an Adaptive-DCT. The inverse intra transform may be an inverse Adaptive-DCT (A-DCT). The intra transform may be a RAHT transform. The inverse intra transform may be an inverse RAHT transform of the RAHT scheme.

Quantization may not be performed, and residual attributes may be entropy encoded (e.g., without transformation) (e.g., at step 2310 and/or 2430), for example, if lossless attribute coding is performed. The intra transform may be a Haar transform, for example, if lossless attribute coding is performed. The inverse intra transform may be an inverse Haar transform, for example, if lossless attribute coding is performed.

Depending on the local predictive quality of the projected attributes (e.g., steps 1742, 1822, 2241), projected attributes may not be used to code the attributes of the current point cloud frame. Projected attributes may not be used to code the attributes of the current point cloud frame, for example, in some regions of the decoded geometry of a current point cloud frame. Projected attributes may not be used to code the attributes of the current point cloud frame, for example, if the correlation between the attributes of the current point cloud frame and the projected attributes is low.

Activation of the use of projected attributes to code the attributes associated with the decoded geometry of the current point cloud frame may be signaled in a bitstream. The signal may be made, for example, by an inter residual activation flag that indicates whether or not projected attributes are used locally. Both or either one of the encoder and decoder may determine if an inter residual activation flag indicates that projected attributes are used or not. Residual attributes may be encoded in bitstream, for example, if the inter residual activation flag indicates that projected attributes are to be used. Residual attributes may not be encoded in the bitstream and/or attributes associated with the decoded geometry of the current point cloud may be encoded by another approach, for example, if the inter residual activation flag indicates that projected attributes are not to be used.

An inter residual activation flag may be associated with a spatial region of the current point cloud frame. The spatial region may comprise a brick (as defined in the High Level Syntax of the GPCC codecs). Bricks may be partitions of the 3D space encompassing the point clouds that each have its own coding parameters that may be independently coded relative to each other. The spatial region may comprise a node or group of nodes of an RAHT octree. A dedicated partitioning of the space may be performed. Each partition part may be associated with an inter residual activation flag.

An inter residual activation flag may be inferred by a quality of prediction of the mapped attributes associated with the reconstructed (e.g., decoded) geometry. No inter residual activation flag may be signaled (e.g., explicitly). A determination as to whether or not the attribute predictors are used for encoding the attributes of the reconstructed geometry may be based on a quality of prediction of the attributes associated with the reconstructed geometry. The quality of prediction may be determined by the encoder. Similarly, at the decoder, a determination as to whether or not the attribute predictors are used for decoding the attributes of the reconstructed geometry may be based on a quality of prediction of the attributes associated with the reconstructed geometry. The quality of prediction may be determined by the decoder.

The quality of prediction may be determined (e.g., assessed), for example, based on a quality metric. The quality metric may be based on differences between mapped attributes and attributes associated with the reconstructed geometry. The quality of projection may be determined, for example, based on a distance of projection. For instances, greater distances of projection may result in lower quality. The distance of projection may be based on differences between vertices associated with attributes of the motion-compensated point cloud frame and vertices associated with the mapped attributes of the decoded geometry. The inter residual activation flag may be used (e.g., deemed as signaled, for example, based on the quality being above a threshold value. The projected attributes may be determined, for example, based on the quality being above the threshold value. The distance may be assessed in step 1740 and/or step 1820.

Alternatively or additionally, an inter residual activation flag may be coded by an encoder in a bitstream and/or decoded by a decoder from a bitstream. An inter residual activation flag may be entropy encoded and/or decoded depending on the quality of prediction. The quality of prediction may be assessed, for example, by the distance of projection as described herein.

Decoding information (e.g., geometry information or attribute information) may indicate decoding information from: at least one single bit (e.g., flag), at least one codeword each comprising more than one bit, or a combination of at least one flag and at least one codeword. Decoding information from a bitstream may indicate parsing the bitstream based on a specific syntax and/or reading from the bitstream: at least one single bit (e.g., flag), at least one codeword each comprising more than one bit, or a combination of at least one flag and at least one word representing the information. Signaling information may comprise encoding the information into a bitstream and/or decoding the information from the bitstream.

FIG. 25 shows an example method for encoding mapped attributes of a point cloud frame. The encoding may be based on transformed coefficients prediction (e.g., transformed attribute coefficients predictors). The transformed coefficients prediction may be determined, for example, from projected attributes. One or more steps of the example method of FIG. 25 (e.g., method 2500) may be performed and/or implemented by an encoder (e.g., encoder 114 of FIG. 1), an example computer system 2900 in FIG. 29, and/or an example computing device 3030 in FIG. 30. Steps (e.g., blocks) of the example method of FIG. 25 may be omitted, performed in other orders, and/or otherwise modified and/or one or more additional steps may be added.

The method 2500 may correspond to step 1750 of FIG. 17. Descriptions with respect to FIG. 25 may refer to portions of FIG. 17. At step 2510, the encoder may determine transformed coefficients 2511. The transformed coefficients 2511 may be determined, for example, by using (e.g., applying) an intra transform to the mapped attribute 1731. At step 2520, the encoder may determine predicted transformed coefficients (e.g., also referred to as transformed attribute coefficients predictors), for example, from the projected attributes 1742. A second intra transform may be used for (e.g., applied to) projected attributes 1742, for example, to determine the predicted transformed coefficients. The second intra transform may be the same intra transform in step 2510, a partial intra transform of the intra transform in step 2510, or a different intra transform. The encoder may determine transformed coefficients residual 2521, for example, by subtracting the predicted transformed coefficients from the transformed coefficients 2511.

At step 2530, the encoder may determine quantized transformed coefficients residual 2531, for example, by quantizing the transformed coefficients residual 2521. The encoder may determine quantized transformed coefficients residual 2531, for example, of lossy compression is performed. Transformed coefficients residual 2521 may be quantized, for example, based on a quantization parameter (e.g., a quantization indicator). The quantization parameter may be used to determine a quantization scaling value/factor. Quantizing may be used, for example, if lossy compression is allowed or enabled.

The operation at step 2530 may be bypassed (e.g., omitted or skipped), for example, if lossless compression is performed. The transformed coefficients residual 2521 may be used at step 2540. In some instances, the quantized transformed coefficients residual 2531 may be equal to the transformed coefficients residual 2521. At step 2540, the encoder may encode (e.g., entropy encode) the transformed coefficient residual 2521 (e.g., if step 2520 is performed) or the quantized transformed coefficients residual 2531 (if step 2530 is performed) into bitstream 1760. The attribute information 1751 may comprise the encoded transformed coefficient residual 2521 or the quantized transformed coefficients residual 2531.

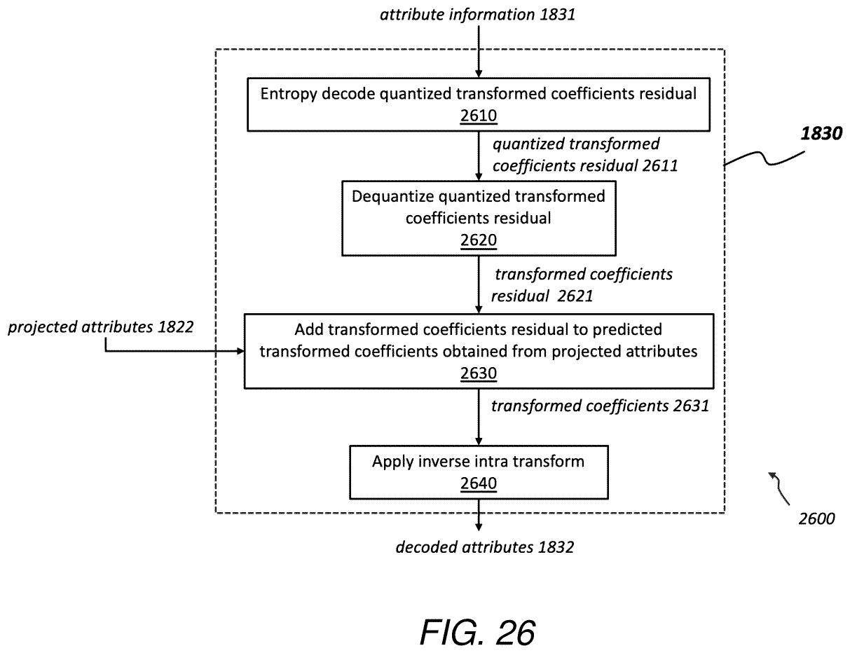

FIG. 26 shows an example method for decoding attribute information of a point cloud frame. The decoding may be based on transformed coefficients prediction (e.g., transformed attribute coefficients predictors). The transformed coefficients prediction may be determined, for example, from projected attributes. One or more steps of the example method of FIG. 26 (e.g., method 2600) may be performed and/or implemented by an encoder (e.g., encoder 120 of FIG. 1), an example computer system 2900 in FIG. 29, and/or an example computing device 3030 in FIG. 30. Steps (e.g., blocks) of the example method of FIG. 26 may be omitted, performed in other orders, and/or otherwise modified and/or one or more additional steps may be added.

The method 2600 may correspond to step 1830 of FIG. 18. Description with respect to FIG. 26 may refer to portions of FIG. 18 as described herein. Step 2600 may reverse (e.g., invert) the operations of step 2500 performed by an encoder, for example, as described herein with respect to FIG. 25. At step 2610, the decoder may determine quantized transformed coefficients residual 2611 (or transformed coefficients residual), for example, by decoding (e.g., entropy decoding) attribute information 1831 from the bitstream 1840.

At step 2620, the decoder may determine a transformed coefficient residual 2621, for example, by dequantizing (e.g., if enabled or implemented) the quantized residual attributes 2611. Transformed coefficients residual 2621 may be dequantized (e.g., inverse quantized), for example, based on a quantization parameter (e.g., a quantization indicator) used to determine an inverse quantization scaling value/factor. The inverse quantization scaling value/factor may be the inverse of the quantization scaling value/factor determined by the encoder, for example, as described herein with respect to step 2530 of FIG. 25.

As described herein with respect to step 2530, quantization may be disabled or not be implemented, for example, for lossless compression. Dequantization may be performed in such instances, and operations in step 2620 may be bypassed (e.g., omitted or skipped). The transformed coefficient residual 2621 may be used at step 2630. In some instances, the quantized transformed coefficients residual 2611 may be equal to the transformed coefficient residual 2621.

At step 2630, the decoder may determine predicted transformed coefficients (e.g., also referred to as transformed attribute coefficients predictors), for example, from the projected attributes 1822. A second intra transform (may be used for (e.g., applied to) projected attributes 1742, for example, to determine the predicted transformed coefficients. The second intra transform may be the same intra transform as described herein with respect to step 2510, a partial intra transform of the intra transform as described herein with respect to step 2510, or a different intra transform. The decoder may determine transformed coefficients 2631, for example, by adding the transformed coefficients residual 2621 to the predicted transformed coefficients.

At step 2640, the decoder may determine decoded attributes 1832, for example, by using (e.g., applying) an inverse intra transform to the transformed coefficients. The operations of the inverse intra transform may correspond to the inverse operations of the intra transform (e.g., as described herein with respect to step 2510 of FIG. 25). Examples of the intra transform referenced in FIG. 25 and/or the corresponding inverse intra transform referenced in FIG. 26 are described herein. The intra transform may be an Adaptive-DCT and/or the inverse intra transform may be an inverse Adaptive-DCT (A-DCT).The intra transform may be a RAHT transform and/or the inverse intra transform may be an inverse RAHT transform of the RAHT scheme. The intra transform may be an integer Haar transform and/or the inverse intra transform may be an inverse integer Haar transform, for example, if lossless attribute coding (e.g., lossless compression) is performed.

In step 2520 and/or step 2630, the predicted transformed coefficients may be obtained, for example, by using (e.g., applying) the intra transform to the projected attributes. The predicted transformed coefficients may be obtained, for example, by using (e.g., applying) a partial intra transform. The partial intra transform may be used to obtain the predicted transformed coefficients, for example, such that a subset of the coefficients may be used for the prediction. The coefficients that are not used for prediction may be set to zero, such that a portion (e.g., the subset) of the coefficients may be used for the prediction. In some instances, less than the whole intra transform may be computed. In some instance, the subset of coefficients may be computed. The subset of coefficients may be fixed. The subset of coefficients may exclude a number (e.g., a predetermined number or based on a threshold) of the highest frequencies' coefficients.

The subset of coefficients may be signaled, in the bitstream, as a number of decomposition levels to be predicted is signaled. The decoder may use the decoded number of decompositions levels to determine the subset of coefficients. The subset of coefficients may be signaled, for example, by following the RAHT decomposition tree. One bit may be signaled, in the bitstream, for a given node, for example, to enable the prediction for that node (e.g., include in the subset coefficient(s) associated with the node). One bit may be signaled, in the bitstream, for a given node, for example, to prune its subtree (e.g., exclude from the subset the coefficient(s) associated with the node as well as all the coefficient(s) associated to child nodes).

FIG. 27 shows an example method for encoding attributes of a point cloud frame. More specifically, FIG. 27 shows a flowchart 2700 of an example method for encoding attributes of a point cloud frame. The point cloud frame may be a current point cloud frame. The encoding may be based on attribute predictors. The method of flowchart 2700 may be performed and/or implemented by an encoder (e.g., encoder 114 in FIG. 1), an example computer system 2900 in FIG. 29, and/or an example computing device 3030 in FIG. 30. The method 2700 may correspond to method 1700 of FIG. 17, as described herein. Steps of the example method of FIG. 27 may be omitted, performed in other orders, and/or otherwise modified, and/or one or more additional steps may be added.

At step 2702, an encoder may determine attributes of a reconstructed geometry of a point cloud frame. The attributes of the reconstructed geometry may be determined, for example, based on attributes of a geometry of the point cloud frame. The determining the attributes of the reconstructed geometry may comprise mapping attributes of the geometry of the point cloud frame to the reconstructed geometry. The attribute predictors may be determined further based on the mapped attributes. The attributes may be colors. The mapped attributes may be determined, for example, based on recoloring. The mapped attributes for each point of the reconstructed geometry may be determined, for example, based on a nearest neighbor search of nearest points, from the geometry, of the point cloud frame, to the point of the reconstructed geometry.

At step 2704, the encoder may determine attribute predictors of the attributes of the reconstructed geometry. The encoder may determine attribute predictors of the attributes of the reconstructed geometry, for example, based on projecting attributes of a reference point cloud frame onto the reconstructed geometry. The reference point cloud frame may be a reference point cloud frame for attributes. The reference point cloud frame for attributes may be an already-coded reference point cloud frame or a motion-compensated point cloud frame. The motion-compensated point cloud frame may be determined, for example, from the already-coded reference point cloud frame (e.g., as described herein with respect to FIG. 17).

At step 2706, the encoder may encode the attributes of the reconstructed geometry. The encoder may encode the attributes of the reconstructed geometry, for example, based on the attribute predictors. The encoder may determine residual attributes, for example, based on differences between the attributes, of the reconstructed geometry, and the attribute predictors. The encoder may encode the residual attributes in a bitstream.

Encoding the residual attributes may include, for example, determining transformed coefficients. The transformed coefficients may be determined, for example, based on using (e.g., applying) an intra transform to the residual attributes. Encoding the residual attributes may include encoding the transformed coefficients corresponding to (e.g., representing or indicating) the residual attributes in the bitstream. Encoding the residual attributes may further include quantizing the transformed coefficients and entropy encoding the quantized transformed coefficients.

FIG. 28 shows an example method for decoding attributes of a point cloud frame. More specifically, FIG. 28 shows a flowchart 2800 of an example method for decoding attributes of a point cloud frame. The point cloud frame may be a current point cloud frame. The decoding may be based on attribute predictors. The method of flowchart 2800 may be performed and/or implemented by a decoder (e.g., decoder 120 in FIG. 1), an example computer system 2900 in FIG. 29, and/or an example computing device 3030 in FIG. 30. The method 2800 may correspond to method 1800 of FIG. 18, as described herein. The decoder may comprise a geometry decoder, an attributes decoder, and/or an attributes projector/determiner, as described herein with respect to FIG. 18.

At step 2802, a decoder (e.g., the geometry decoder) may decode a geometry of a point cloud frame to determine a reconstructed geometry of the point cloud frame. The decoder may decode, for example, geometry information of the point cloud from a bitstream. The decoded geometry may correspond to the geometry of the point cloud frame reconstructed (e.g., encoded and then decoded) at an encoder. To decode the attributes associated with the reconstructed geometry, the decoder may decode, from a bitstream, residual attributes. The residual attributes may indicate differences between the attributes, of the reconstructed geometry, and the attribute predictors. The decoded attributes may be determined, for example, based on adding the attribute predictors and the decoded residual attributes.

Decoding the residual attributes may comprise decoding (e.g., entropy decoding), from the bitstream, transformed coefficients corresponding to (e.g., representing or indicating) the residual attributes. The residual attributes may be determined, for example, based on using (e.g., applying) an inverse intra transform to the decoded transformed coefficients. Decoding the residual attributes may further comprise dequantizing the transformed coefficients. The residual attributes may be determined by using (e.g., applying) the inverse intra transform to the dequantized transformed coefficients.

At step 2804, the decoder may determine attribute predictors of attributes of the reconstructed geometry, for example, based on projecting attributes of a reference point cloud frame, for attributes, onto the reconstructed geometry. The reference point cloud frame for attributes may be an already-coded reference point cloud frame or a motion-compensated point cloud frame. The motion-compensated point cloud frame may be determined, for example, from the already-coded reference point cloud frame (e.g., as described herein with respect to FIG. 18).

At step 2806, the decoder may decode the attributes of the reconstructed geometry, for example, based on the attribute predictors. As described herein, attributes predictors may be determined reciprocally (e.g., independently and/or identically) at the encoder and the decoder. The attribute predictors may be determined, for example, based on projecting attributes of a motion-compensated point cloud frame to a reconstructed geometry of the point cloud frame. The attribute predictors may comprise a respective attribute predictor for each respective point of points of the reconstructed geometry. The respective attribute predictor may be based on a projected attribute, of the projected attributes, corresponding to the point. The determining the attribute predictors may comprise smoothing the projected attributes. The predicted attributes may be determined from the smoothed projected attributes.

The motion compensated point cloud frame may be determined from an already-coded reference point cloud frame. The motion-compensated point cloud frame may be determined, for example, based on motion compensating the already-coded reference point cloud frame. The motion compensating may be based on a motion vector (MV). The motion vector may be determined, for example, based on differences between the reconstructed geometry and a geometry, of the already-coded reference point cloud frame, adjusted by the motion vector. A motion vector that reduces distortion may be selected as the determined motion vector. The motion vector and/or an indication (e.g., an index or ID) of the already-coded reference point cloud frame may be signaled in the bitstream (e.g., encoded by the encoder and/or decoded by the decoder).

As described herein, the attributes predictors may be used to determine residual attributes (e.g., at the encoder) and/or combined with decoded residual attributes (e.g., at the decoder) to decode (e.g., reconstruct) attributes at the decoder. The residual attributes may be encoded and/or decoded, for example, based on an intra transform scheme (e.g., a prediction with lifting (pred-lift) transform scheme, an Adaptive-DCT and a corresponding inverse A-DCT, a RAHT transform and a corresponding inverse RAHT transform of a RAHT scheme, a Haar transform and/or a corresponding inverse Haar transform).

FIG. 29 shows an example computer system in which examples of the present disclosure may be implemented. For example, the example computer system 2900 shown in FIG. 29 may implement one or more of the methods described herein. For example, various devices and/or systems described herein (e.g., in FIGS. 1, 2, and 3) may be implemented in the form of one or more computer systems 2900. Furthermore, each of the steps of the flowcharts depicted in this disclosure may be implemented on one or more computer systems 2900.

The computer system 2900 may comprise one or more processors, such as a processor 2904. The processor 2904 may be a special purpose processor, a general purpose processor, a microprocessor, and/or a digital signal processor. The processor 2904 may be connected to a communication infrastructure 2902 (for example, a bus or network). The computer system 2900 may also comprise a main memory 2906 (e.g., a random access memory (RAM)), and/or a secondary memory 2908.

The secondary memory 2908 may comprise a hard disk drive 2910 and/or a removable storage drive 2912 (e.g., a magnetic tape drive, an optical disk drive, and/or the like). The removable storage drive 2912 may read from and/or write to a removable storage unit 2916. The removable storage unit 2916 may comprise a magnetic tape, optical disk, and/or the like. The removable storage unit 2916 may be read by and/or may be written to the removable storage drive 2912. The removable storage unit 2916 may comprise a computer usable storage medium having stored therein computer software and/or data.

The secondary memory 2908 may comprise other similar means for allowing computer programs or other instructions to be loaded into the computer system 2900. Such means may include a removable storage unit 2918 and/or an interface 2914. Examples of such means may comprise a program cartridge and/or cartridge interface (such as in video game devices), a removable memory chip (such as an erasable programmable read-only memory (EPROM) or a programmable read-only memory (PROM)) and associated socket, a thumb drive and USB port, and/or other removable storage units 2918 and interfaces 2914 which may allow software and/or data to be transferred from the removable storage unit 2918 to the computer system 2900.

The computer system 2900 may also comprise a communications interface 2920. The communications interface 2920 may allow software and data to be transferred between the computer system 2900 and external devices. Examples of the communications interface 2920 may include a modem, a network interface (e.g., an Ethernet card), a communications port, etc. Software and/or data transferred via the communications interface 2920 may be in the form of signals which may be electronic, electromagnetic, optical, and/or other signals capable of being received by the communications interface 2920. The signals may be provided to the communications interface 2920 via a communications path 2922. The communications path 2922 may carry signals and may be implemented using wire or cable, fiber optics, a phone line, a cellular phone link, an RF link, and/or any other communications channel(s).

A computer program medium and/or a computer readable medium may be used to refer to tangible storage media, such as removable storage units 2916 and 2918 or a hard disk installed in the hard disk drive 2910. The computer program products may be means for providing software to the computer system 2900. The computer programs (which may also be called computer control logic) may be stored in the main memory 2906 and/or the secondary memory 2908. The computer programs may be received via the communications interface 2920. Such computer programs, when executed, may enable the computer system 2900 to implement the present disclosure as discussed herein. In particular, the computer programs, when executed, may enable the processor 2904 to implement the processes of the present disclosure, such as any of the methods described herein. Accordingly, such computer programs may represent controllers of the computer system 2900.

Features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

FIG. 30 shows example elements of a computing device that may be used to implement any of the various devices described herein, including, for example, a source device (e.g., 102), an encoder (e.g., 114), a destination device (e.g., 106), a decoder (e.g., 120), and/or any computing device described herein. The computing device 3030 may include one or more processors 3031, which may execute instructions stored in the random-access memory (RAM) 3033, the removable media 3034 (such as a Universal Serial Bus (USB) drive, compact disk (CD) or digital versatile disk (DVD), or floppy disk drive), or any other desired storage medium. Instructions may also be stored in an attached (or internal) hard drive 3035. The computing device 3030 may also include a security processor (not shown), which may execute instructions of one or more computer programs to monitor the processes executing on the processor 3031 and any process that requests access to any hardware and/or software components of the computing device 3030 (e.g., ROM 3032, RAM 3033, the removable media 3034, the hard drive 3035, the device controller 3037, a network interface 3039, a GPS 3041, a Bluetooth interface 3042, a WiFi interface 3043, etc.). The computing device 3030 may include one or more output devices, such as the display 3036 (e.g., a screen, a display device, a monitor, a television, etc.), and may include one or more output device controllers 3037, such as a video processor. There may also be one or more user input devices 3038, such as a remote control, keyboard, mouse, touch screen, microphone, etc. The computing device 3030 may also include one or more network interfaces, such as a network interface 3039, which may be a wired interface, a wireless interface, or a combination of the two. The network interface 3039 may provide an interface for the computing device 3030 to communicate with a network 3040 (e.g., a RAN, or any other network). The network interface 3039 may include a modem (e.g., a cable modem), and the external network 3040 may include communication links, an external network, an in-home network, a provider's wireless, coaxial, fiber, or hybrid fiber/coaxial distribution system (e.g., a DOCSIS network), or any other desired network. Additionally, the computing device 3030 may include a location-detecting device, such as a global positioning system (GPS) microprocessor 3041, which may be configured to receive and process global positioning signals and determine, with possible assistance from an external server and antenna, a geographic position of the computing device 3030.

The example in FIG. 30 may be a hardware configuration, although the components shown may be implemented as software as well. Modifications may be made to add, remove, combine, divide, etc. components of the computing device 3030 as desired. Additionally, the components may be implemented using basic computing devices and components, and the same components (e.g., processor 3031, ROM storage 3032, display 3036, etc.) may be used to implement any of the other computing devices and components described herein. For example, the various components described herein may be implemented using computing devices having components such as a processor executing computer-executable instructions stored on a computer-readable medium, as shown in FIG. 30. Some or all of the entities described herein may be software based, and may co-exist in a common physical platform (e.g., a requesting entity may be a separate software process and program from a dependent entity, both of which may be executed as software on a common computing device).

A computing device may perform a method comprising multiple operations. The computing device may comprise a decoder. The computing device may, determine, based on decoding geometry information of a point could frame associated with content, a reconstructed geometry of the point cloud frame. The computing device may determine, based on projecting attributes, of a reference point cloud frame, onto the reconstructed geometry, attribute predictors associated with the reconstructed geometry. The computing device may determine attribute predictors, associated with the reconstructed geometry, based on projecting attributes of a reference point cloud frame onto the reconstructed geometry. The computing device may decode the attribute information of the reconstructed geometry by decoding, from a bitstream, residual attributes indicating differences between the attribute information of the reconstructed geometry and the attribute predictors. The computing device may determine, based on the attribute predictors and the residual attributes, the attribute information of the reconstructed geometry. The computing device may decode of the residual attributes by decoding, from the bitstream, transformed coefficients corresponding to the residual attributes. The computing device may apply an inverse intra transform to the decoded transformed coefficients. The computing device may further decode, from the bitstream, transformed coefficients corresponding to the residual attributes. The computing device may dequantize the decoded transformed coefficients. The computing device may decode the attribute information of the reconstructed geometry by determining, by applying an intra transform to the attribute predictors, transformed attribute predictors; determining transformed residual attributes indicating differences between transformed attributes of the reconstructed geometry and the transformed attribute predictors; determining, based on the transformed attribute predictors and the decoded transformed residual attributes, the transformed attributes of the reconstructed geometry; and applying an inverse intra transform to the transformed attributes of the reconstructed geometry. The computing device may determine the transformed residual attributes by: decoding transformed coefficients corresponding to the transformed residual attributes; and dequantizing the transformed coefficients. The intra transform may comprise at least one of: an Adaptive-DCT; a RAHT transform; or a Haar transform. An already-coded reference point cloud frame, associated with the reference point cloud frame, may be used to decode the geometry information of the point cloud frame. The determining the attribute predictors may comprise smoothing the projected attributes of the reference point cloud frame. The computing device may comprise one or more processors and memory, storing instructions that, when executed by the one or more processors, perform the method described herein. A system may comprise the computing device configured to perform the described method, additional operations, and/or include additional elements; and a second computing device configured to encode the point cloud frame. A computer-readable medium may store instructions that, when executed, cause performance of the described method, additional operations, and/or include additional elements.

A computing device may perform a method comprising multiple operations. The computing device may comprise an encoder. The computing device may determine a reconstructed geometry of a point cloud frame associated with content. The computing device may determine attribute predictors, associated with the reconstructed geometry, based on projecting attributes of a reference point cloud frame onto the reconstructed geometry. The computing device may encode, based on the attribute predictors, attribute information associated with the reconstructed geometry. The computing device may encode the attribute information by: determining, based on differences between attribute information of the reconstructed geometry and the attribute predictors, residual attributes; and encoding, into a bitstream associated with the point cloud frame, the residual attributes. The computing device may encode the residual attributes by: determining, based on applying an intra transform to the residual attributes, transformed coefficients; and entropy encoding, in the bitstream, the transformed coefficients corresponding to the residual attributes. The computing device may quantize, before the entropy encoding, the transformed coefficients. The computing device may determine the attribute predictors further based on mapping attribute information of the geometry to the reconstructed geometry. The attribute information of the reconstructed geometry may comprise colors. The computing device may comprise one or more processors and memory, storing instructions that, when executed by the one or more processors, perform the method described herein. A system may comprise the computing device configured to perform the described method, additional operations, and/or include additional elements; and a second computing device configured to decode the point cloud frame. A computer-readable medium may store instructions that, when executed, cause performance of the described method, additional operations, and/or include additional elements.

A computing device may perform a method comprising multiple operations. A computing device may comprise a decoder. A computing device may determine, based on projecting attributes, of a reference point cloud frame, onto a geometry of a point cloud frame, attribute predictors associated with the geometry. A computing device may receive, from a bitstream, residual attributes indicating differences between the attribute predictors and attribute information of the geometry. A computing device may decode the residual attributes using the attribute predictors to determine attributes associated with the geometry of the point cloud frame. A computing device may receive the residual attributes by: receiving transformed coefficients corresponding to the residual attributes; and applying an inverse intra transform to the decoded transformed coefficients. The intra transform may comprise at least one of: an Adaptive-DCT; a RAHT transform; or a Haar transform. An already-coded reference point cloud frame, associated with the reference point cloud frame, is used to decode the geometry information of the point cloud frame. The computing device may comprise one or more processors and memory, storing instructions that, when executed by the one or more processors, perform the method described herein. A system may comprise the computing device configured to perform the described method, additional operations, and/or include additional elements; and a second computing device configured to encode the point cloud frame. A computer-readable medium may store instructions that, when executed, cause performance of the described method, additional operations, and/or include additional elements.

A computing device may perform a method comprising multiple operations. The computing device may comprise an encoder. The computing device may determine, attribute predictors, associated with the geometry, based on projecting attributes of a reference point cloud frame onto a geometry of a point cloud frame. The computing device may encode, in a bitstream, residual attributes indicating differences between the attribute predictors and attribute information of the geometry. The computing device may encode the residual attributes by: determine, based on applying an inverse intra transform to the residual attributes, transformed coefficients; and entropy encode, in the bitstream, the transformed coefficients corresponding to the residual attributes. The inverse intra transform may comprise at least one of: an inverse Adaptive-DCT; an inverse RAHT transform; or an inverse Haar transform. The computing device may comprise one or more processors and memory, storing instructions that, when executed by the one or more processors, perform the method described herein. A system may comprise the computing device configured to perform the described method, additional operations, and/or include additional elements; and a second computing device configured to decode the point cloud frame. A computer-readable medium may store instructions that, when executed, cause performance of the described method, additional operations, and/or include additional elements.

A computing device may perform a method comprising multiple operations. The computing device may be an encoder. The computing device may determine attribute information of a reconstructed geometry of a point cloud frame based on attribute information of a geometry of the point cloud frame. The computing device may determine attribute predictors of the attribute information of the reconstructed geometry based on projecting attributes of a reference point cloud frame for attributes onto the reconstructed geometry. The computing device may encode the attribute information of the reconstructed geometry based on the attribute predictors. The computing device may determine the attribute information of the reconstructed geometry by: mapping attributes of the geometry of the point cloud frame to the reconstructed geometry, and wherein the attribute predictors may be determined further based on the mapped attributes. The attributes may be colors and the mapped attributes may be determined based on recoloring. The mapped attributes for each point of the reconstructed geometry may be determined based on a nearest neighbor search of nearest points, from the geometry of the point cloud frame, to the point of the reconstructed geometry. The computing device may encode the attributes by: determining residual attributes based on differences between the attributes of the reconstructed geometry and the attribute predictors; and encoding, in a bitstream, the residual attributes. The computing device may encode the residual attributes by: determining transformed coefficients based on applying an intra transform to the residual attributes; and entropy encoding, in the bitstream, the transformed coefficients corresponding to the residual attributes. The computing device may quantize the transformed coefficients, the quantized transformed coefficients being entropy encoded. The residual attributes may be encoded and decoded based on a prediction with lifting (pred-lift) transform scheme. The reference point cloud frame for attributes may be determined from an already-coded reference point cloud frame. The already-coded reference point cloud frame may be used to encode or decode the geometry of the point cloud frame. The reference point cloud frame for attributes may be determined based on motion compensating the already-coded reference point cloud frame to determine a motion compensated point cloud frame. The already-coded reference point cloud frame may be motion compensated by a motion vector. The computing device may encode the motion vector and/or an indication of the already-coded reference point cloud frame. The computing device may determine the motion vector based on differences between the reconstructed geometry and a geometry, of the already-coded reference point cloud frame, adjusted by the motion vector. The computing device may determine the attribute predictors by smoothing the projected attributes, the predicted attributes being determined from the smoothed projected attributes. The attribute predictors may comprise a respective attribute predictor, for each respective point of points of the reconstructed geometry, that is based on a projected attribute, of the projected attributes, corresponding to the point. The computing device may encode (or signal), in a bitstream, an inter residual activation flag indicating whether the attributes are encoded based on the attribute predictors. The inter residual activation flag may be encoded based on a quality of projection of the attributes associated with the reconstructed geometry. The attribute information of the reconstructed geometry may be encoded using the attribute predictors based on a quality of prediction of the attributes associated with the reconstructed geometry. The quality of projection may be determined based a distance of projection of the attributes associated with the decoded geometry. The inter residual activation flag may be associated with a spatial region of the point cloud frame. The computing device may encode the geometry of the point cloud frame and determine the reconstructed geometry based on decoding the encoded geometry. The computing device may comprise one or more processors and memory, storing instructions that, when executed by the one or more processors, perform the method described herein. A system may comprise the computing device configured to perform the described method, additional operations, and/or include additional elements; and a second computing device configured to decode the point cloud frame. A computer-readable medium may store instructions that, when executed, cause performance of the described method, additional operations, and/or include additional elements.

A computing device may perform a method comprising multiple operations. The computing device may comprise a decoder. The computing device may decode a geometry of a point cloud frame to determine a reconstructed geometry of the point cloud frame. The computing device may determine attribute predictors of attributes of the reconstructed geometry based on projecting attributes of a reference point cloud frame for attributes onto the reconstructed geometry. The computing device may decode the attribute information of the reconstructed geometry based on the attribute predictors. The computing device may decode the attributes associated with the reconstructed geometry by: decoding, from a bitstream, residual attributes indicating differences between the attributes of the reconstructed geometry and the attribute predictors; and determining the decoded attributes based on adding the attribute predictors and the decoded residual attributes. The computing device may decode of the residual attributes by: entropy decoding, from the bitstream, transformed coefficients corresponding to the residual attributes; determining the residual attributes based on applying an inverse intra transform to the decoded transformed coefficients. The computing device may dequantize the transformed coefficients, the residual attributes being determined by applying the inverse intra transform to the dequantized transformed coefficients. The reference point cloud frame for attributes may be determined from an already-coded reference point cloud frame. The already-coded reference point cloud frame may be used to encode or decode the geometry of the point cloud frame. The reference point cloud frame for attributes may be determined based on motion compensating the already-coded reference point cloud frame to determine a motion compensated point cloud frame. The already-coded reference point cloud frame is motion compensated by a motion vector. The computing device may encode the motion vector and/or an indication of the already-coded reference point cloud frame. The computing device may determine the motion vector based on differences between the reconstructed geometry and a geometry, of the already-coded reference point cloud frame, adjusted by the motion vector. The computing device may determine the attribute predictors comprises smoothing the projected attributes, the predicted attributes being determined from the smoothed projected attributes. The attribute predictors may comprise a respective attribute predictor, for each respective point of points of the reconstructed geometry, that is based on a projected attribute, of the projected attributes, corresponding to the point. The computing device may receive, from a bitstream, an inter residual activation flag indicating whether the attributes are coded based on the attribute predictors, wherein the determining the attribute predictors may be based on the inter residual activation flag. The attribute information of the reconstructed geometry may be decoded using the attribute predictors based on a quality of prediction of the attributes associated with the reconstructed geometry. The quality of projection may be determined based a distance of projection of the attributes associated with the decoded geometry. The inter residual activation flag may be associated with a spatial region of the point cloud frame. The computing device may decode the attributes associated with the reconstructed geometry by applying an intra transform to the attribute predictors; decoding, from a bitstream, transformed residual attributes indicating differences between transformed attributes of the reconstructed geometry and the transformed attribute predictors; determining the transformed attributes based on adding the transformed attribute predictors and the decoded transformed residual attributes; and determining the decoded attributes based on applying an inverse intra transform to the determined transformed attributes. The computing device may decode of the transformed residual attributes by: entropy decode, from the bitstream, transformed coefficients corresponding to the transformed residual attributes; and dequantize the transformed coefficients to determine the transformed residual attributes. The computing device may comprise one or more processors and memory, storing instructions that, when executed by the one or more processors, perform the method described herein. A system may comprise the computing device configured to perform the described method, additional operations, and/or include additional elements; and a second computing device configured to encode the point cloud frame. A computer-readable medium may store instructions that, when executed, cause performance of the described method, additional operations, and/or include additional elements.

One or more examples herein may be described as a process which may be depicted as a flowchart, a flow diagram, a data flow diagram, a structure diagram, and/or a block diagram. Although a flowchart may describe operations as a sequential process, one or more of the operations may be performed in parallel or concurrently. The order of the operations shown may be re-arranged. A process may be terminated when its operations are completed, but could have additional steps not shown in a figure. A process may correspond to a method, a function, a procedure, a subroutine, a subprogram, etc. If a process corresponds to a function, its termination may correspond to a return of the function to the calling function or the main function.

Operations described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks. Features of the disclosure may be implemented in hardware using, for example, hardware components such as application-specific integrated circuits (ASICs) and gate arrays. Implementation of a hardware state machine to perform the functions described herein will also be apparent to persons skilled in the art.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein. Computer-readable medium may comprise, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

A non-transitory tangible computer readable media may comprise instructions executable by one or more processors configured to cause operations described herein. An article of manufacture may comprise a non-transitory tangible computer readable machine-accessible medium having instructions encoded thereon for enabling programmable hardware to cause a device (e.g., an encoder, a decoder, a transmitter, a receiver, and the like) to allow operations described herein. The device, or one or more devices such as in a system, may include one or more processors, memory, interfaces, and/or the like.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more of the operations described herein may be conditional. For example, one or more operations may be performed if certain criteria are met, such as in computing device, a communication device, an encoder, a decoder, a network, a combination of the above, and/or the like. Example criteria may be based on one or more conditions such as device configurations, traffic load, initial system set up, packet sizes, traffic characteristics, a combination of the above, and/or the like. If the one or more criteria are met, various examples may be used. It may be possible to implement any portion of the examples described herein in any order and based on any condition.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
determining, by a decoder and based on decoding geometry information of a point could frame associated with content, a reconstructed geometry of the point cloud frame;
determining attribute predictors, associated with the reconstructed geometry, based on projecting attributes of a reference point cloud frame onto the reconstructed geometry; and
decoding, based on the attribute predictors, attribute information of the reconstructed geometry.

2. The method of claim 1, wherein the decoding the attributes of the reconstructed geometry comprises:
decoding, from a bitstream, residual attributes indicating differences between the attributes of the reconstructed geometry and the attribute predictors; and
determining, based on the attribute predictors and the residual attributes, the attributes of the reconstructed geometry.

3. The method of claim 2, wherein the decoding of the residual attributes comprises:
decoding, from the bitstream, transformed coefficients corresponding to the residual attributes; and
applying an inverse intra transform to the decoded transformed coefficients.

4. The method of claim 2, further comprising:
decoding, from the bitstream, transformed coefficients corresponding to the residual attributes; and
dequantizing the decoded transformed coefficients.

5. The method of claim 1, wherein the decoding the attributes of the reconstructed geometry comprises:
determining, by applying an intra transform to the attribute predictors, transformed attribute predictors;
determining transformed residual attributes indicating differences between transformed attributes of the reconstructed geometry and the transformed attribute predictors;
determining, based on the transformed attribute predictors and the transformed residual attributes, the transformed attributes of the reconstructed geometry; and
applying an inverse intra transform to the transformed attributes of the reconstructed geometry.

6. The method of claim 5, wherein the determining the transformed residual attributes comprises:
decoding transformed coefficients corresponding to the transformed residual attributes; and
dequantizing the transformed coefficients.

7. The method of claim 5, wherein the intra transform comprises at least one of:
an Adaptive-DCT;
a RAHT transform; or
a Haar transform.

8. The method of claim 1, wherein an already-coded reference point cloud frame, associated with the reference point cloud frame, is used to decode the geometry information of the point cloud frame.

9. The method of claim 1, wherein the determining the attribute predictors comprises smoothing the projected attributes of the reference point cloud frame.

10. A method comprising:
determining, by an encoder, a reconstructed geometry of a point cloud frame associated with content;
determining attribute predictors, associated with the reconstructed geometry, based on projecting attributes of a reference point cloud frame onto the reconstructed geometry; and
encoding, based on the attribute predictors, attribute information associated with the reconstructed geometry.

11. The method of claim 10, wherein the encoding the attribute information comprises:
determining, based on differences between the attributes of the reconstructed geometry and the attribute predictors, residual attributes; and
encoding, into a bitstream associated with the point cloud frame, the residual attributes.

12. The method of claim 11, wherein the encoding the residual attributes comprises:
determining, based on applying an intra transform to the residual attributes, transformed coefficients; and
entropy encoding, in the bitstream, the transformed coefficients corresponding to the residual attributes.

13. The method of claim 12, further comprising quantizing, before the entropy encoding, the transformed coefficients.

14. The method of claim 10, wherein the determining the attribute predictors is further based on mapping attributes of the geometry to the reconstructed geometry.

15. The method of claim 10, wherein the attributes of the reconstructed geometry comprise colors.

16. The method of claim 12, wherein the intra transform comprises at least one of:
an Adaptive-DCT;
a RAHT transform; or
a Haar transform.

17. A method comprising:
determining, by a decoder and based on projecting attributes, of a reference point cloud frame, onto a geometry of a point cloud frame, attribute predictors associated with the geometry;
receiving, from a bitstream, residual attributes indicating differences between the attribute predictors and attributes of the geometry; and
decoding the residual attributes using the attribute predictors to determine attributes associated with the geometry of the point cloud frame.

18. The method of claim 17, wherein the receiving the residual attributes comprises:
receiving transformed coefficients corresponding to the residual attributes; and
applying an inverse intra transform to the transformed coefficients.

19. The method of claim 18, wherein the intra transform comprises at least one of:
an Adaptive-DCT;
a RAHT transform; or
a Haar transform.

20. The method of claim 17, further comprising:
decoding, based on an already-coded reference point cloud frame associated with the reference point cloud frame, the geometry of the point cloud frame.
